(19) United States
(12) Patent Application Publication
(10) Pub. No.: US 2005/0229250 A1
(43) Pub. Date: Oct. 13, 2005

(54) Methodology, system, computer readable medium, and product providing a security software suite for handling operating system exploitations

(76) Inventors: Sandra E. Ring, Alexandria, VA (US); Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/789,460

(22) Filed: Feb. 26, 2004

(51) Int. Cl. G06F 11/00

(52) U.S. Cl. 726/23

(57) ABSTRACT

Various embodiments are provided relating to security of a computer, namely, a security software product, a computer-readable medium, a computerized method, and a computer security system. Illustrative is one embodiment of a security software product for use on a host computer to monitor for, and respond to, activity corresponding to a rootkit exploitation which renders the host computer's operating system insecure. The security software product comprises computer readable media having a suite of interfaced software components, such as loadable kernel modules. An exploitation detection component detects the activity corresponding to the rootkit exploitation. A forensics data collection component collects forensics data characteristic of the rootkit exploitation so that it may be transferred to a removable storage device. An OS restoration component restores the operating system to a secure condition in response to detection of the exploit.

### BACKGROUND OF THE INVENTION

The present invention generally concerns the detection of, collection of, and recovery from, activity and data characteristic of a computer system exploitation, such as surreptitious rootkit installations. To this end, the invention particularly pertains to the fields of intrusion detection, computer forensics, as well as operating system repair and maintenance.

### Operating System Exploitations

The increase in occurrence and complexity of operating system (OS) compromises makes manual analysis and detection difficult and time consuming. To make matters worse, most reasonably functioning detection methods are not capable of discovering surreptitious exploits, such as new rootkit installations, because they are designed to statically search the operating system for previously derived signatures only. More robust techniques aimed at identifying unknown rootkits typically require installation previous to the attack and periodic offline static analysis. Prior installation is often not practical and many, if not most, production systems cannot accept the tremendous performance impact of being frequently taken offline.

The integration of biological analogies into computer paradigms is not new and has been a tremendous source of inspiration and ingenuity for well over a decade. Perhaps the most notable of the analogies occurred in 1986 when Len Adleman coined the phrase “computer virus” while advising Fred Cohen on his PhD thesis on self-replicating software. The association between the biological immune system and fighting computer viruses was made by Jeffrey Kephart and was generalized to all aspects of computer security by Forrest, Perelson, Allen, and Cheruki in 1994. Although the biological immune system is far from perfect it is still well beyond the sophistication of current computer security approaches. Much can be learned by analyzing the strengths and weaknesses of what thousands of years of evolution have produced.

The continual increase of exploitable software on computer networks has led to an epidemic of malicious activity by hackers and an especially hard challenge for computer security professionals. One of the more difficult and still unsolved problems in computer security involves the detection of exploitation and compromise of the operating system itself. Operating system compromises are particularly problematic because they corrupt the integrity of the very tools that administrators rely on for intruder detection. In the biological world this is analogous to auto-immune diseases such as AIDS. These attacks are distinguished by the installation of rootkits.

A rootkit is a common name for a collection of software tools that provides an intruder with concealed access to an exploited computer. Contrary to the implication by their name, rootkits are not used to gain root access. Instead they are responsible for providing the intruder with such capabilities as (1) hiding processes, (2) hiding network connections, and (3) hiding files. Like auto-immune diseases, rootkits deceive the operating system into recognizing the foreign intruder's behavior as “self” instead of a hostile pathogen.

Rootkits are generally classified into two categories—application level rootkits and kernel modifications. To the user, the behavior and properties of both application level and kernel level rootkits are identical; the only real difference between the two is their implementation. Application rootkits are commonly referred to as Trojans because they operate by placing a “Trojan Horse” within a trusted application (i.e., ps, ls, netstat, etc.) on the exploited computer. Popular examples of application rootkits include T0rn and Lrk5. Many application level rootkits operate by physically replacing or modifying files on the hard drive of the target computer. This type of examination can be easily automated by comparing the checksums of the executables on the hard drive to known values of legitimate copies. Tripwire is a good example of a utility that does this.

Kernel rootkits are identical capability wise, but function quite differently. Kernel level rootkits consist of programs capable of directly modifying the running kernel itself. They are much more powerful and difficult to detect because they can subvert any application level program, without physically “trojaning” it, by corrupting the underlying kernel functions. Instead of trojaning programs on disk, kernel rootkits generally modify the kernel directly in memory as it is running. Intruders will often install them and then securely delete the file from the disk using a utility such as fwipe or overwrite. This can make detection exceedingly difficult because there is no physical file left on the disk. Popular examples of kernel level rootkits such as SuckiT and Adore can sometimes be identified using the utility Chkrootkit. However, this method is signature based and is only able to identify a rootkit that it has been specifically programmed to detect. In addition, utilities such as this do not have the functionality to collect rootkits or protect evidence on the hard drive from accidental influence. Moreover, file based detection methods such as Tripwire are not effective against kernel level rootkits.

Rootkits are often used in conjunction with sophisticated command and control programs frequently referred to as “backdoors.” A backdoor is the intruder's secret entrance into the computer system that is usually hidden from the administrator by the rootkit. Backdoors can be implemented via simple TCP/UDP/ICMP port listeners or via incorporation of complex stealthy trigger packet mechanisms. Popular examples include netcat, icmp-shell, udp-backdoor, and ddb-ste. In addition to hiding the binary itself, rootkits are typically capable of hiding the backdoor's process and network connections as well.

Known rootkit detection methods are essentially discrete algorithms of anomaly identification. Models are created and any deviation from them indicates an anomaly. Models are either based on the set of all anomalous instances (negative detection) or all allowed behavior (positive detection). Much debate has taken place in the past over the benefit of positive verses negative detection methods, and each approach has enjoyed reasonable success.

Negative detection models operate by maintaining a set of all anomalous (non-self) behavior. The primary benefit to negative detection is its ability to function much like the biological immune system in its deployment of “specialized” sensors. However, it lacks the ability to “discover” new attack methodologies. Signature based models, such as Chkrootkit noted above, are implementations of negative detection. Chkrootkit maintains a collection of signatures for all known rootkits (application and kernel). This is very similar to mechanisms employed by popular virus detectors. Although successful against them, negative detection schemes are only effective against “known” rootkit signatures, and thus have inherent limitations. This means that these systems are incapable of detecting new rootkits that have not yet had signatures distributed. Also, if an existing rootkit is modified slightly to adjust its signature it will no longer be detected by these programs. Chkrootkit is only one rootkit detection application having such a deficiency, and users of this type of system must continually acquire new signatures to defend against the latest rootkits, which increases administrator workload rather than reducing it. Because computer system exploits evolve rapidly, this solution will never be complete and users of negative detection models will always be “chasing” to catch up with offensive technologies.

Positive detection models operate by maintaining a set of all acceptable (self) behavior. The primary benefit to positive detection is that it allows for a smaller subset of data to be stored and compared; however accumulation of this data must take place prior to an attack for integrity assurance. One category of positive detection is the implementation of change detection. A popular example of a change detection algorithm is Tripwire, referred to above, which operates by generating a mathematical baseline using a cryptographic hash of files within the computer system immediately following installation (i.e., while it is still “trusted”). It assumes that the initial install is not infected. Tripwire maintains a collection of what it considers to be self, and anything that deviates or changes is anomalous. Periodically the computer system is examined and compared to the initial baseline. Although this method is robust because, unlike negative detection, it is able to “discover” new rootkits, it is often unrealistic. Few system administrators have the luxury of being present to develop the baseline when the computer system is first installed. Most administer systems that are already loaded, and therefore are not able to create a trusted baseline to start with. Moreover, this approach is incapable of detecting rootkits “after the fact” if a baseline or clean system backup was not previously developed. In an attempt to solve this limitation, some change detection systems such as Tripwire provide access to a database of trusted signatures for common operating system files. Unfortunately this is only a small subset of the files on the entire system.

Another drawback with static change analysis is that the baseline for the system is continually evolving. Patches and new software are continually being added and removed from the system. These methods can only be run against files that are not supposed to change. Instead of reducing the amount of workload for the administrator, the constant requirement to re-baseline with every modification dramatically increases it. Furthermore, current implementations of these techniques require that the system be taken offline for inspection when detecting the presence of kernel rootkits. Therefore, a need remains to develop a more robust approach to detecting operating system exploits in general, and surreptitious rootkit installs in particular, which does not suffer from the drawbacks associated with known positive and negative detection models.

### Computer Forensics

The goal of computer forensics is to recover digital crime evidence for an investigation in a manner which will be admissible in a court of law. These requirements vary depending of venue, but in general the acquisition method must be thoroughly tested with documented error rates and stand up to peer scrutiny. Evidence can be found on the hard drive (non-volatile memory) and in RAM (volatile memory). To protect the condition of the evidence, any technique used must guarantee the integrity or purity of what is recovered. Traditionally, immediately turning off the computer following an incident is recommended to accomplish this in order that a backup be made of the hard drive. Unfortunately all volatile memory is lost when the power is turned off, thus limiting an investigation by destroying all evidence located in volatile memory. However, if a backup to the hard drive is made of the volatile memory prior to shutdown, critical data on the non-volatile memory can be corrupted. A dilemma is thus created since both types of memory can contain significant data which could be vital to the investigation. To date, however, investigators have had to choose collection of volatile or non-volatile memory, thus potentially sacrificing collection of the other. Moreover, investigators have had to make these decisions without the benefit of prior inspection to ascertain which memory bank actually contains the most credible evidence.

Volatile memory contains additional data that can be significant to a case including processes (backdoors, denial of service programs, etc), kernel modifications (rootkits), command line history, copy and paste buffers, and passwords. Accordingly, rootkits are not the only evidence of interest found in volatile memory; since intruders often run several processes on systems that they compromise as well. These processes are generally hidden by the rootkit and are often used for covert communication, denial of service attacks, collection, and as backdoor access. These processes can either reside on disk so they can be restarted following a reboot, or they are located only in memory to prevent collection by standard non-volatile memory forensics techniques. Without this data, the signs of an intruder can disappear with the stroke of the power button. This is why some attackers try to reboot a system after their attack to limit the data that is available to a forensics expert. In addition, intruders sometimes implement “bug out” functions in software that are triggered when an administrator searches for anomalous behavior. These features can do anything from immediately halting a process to more disruptive behaviors such as deleting all files on the hard drive. All of these factors make collection of memory evidence extremely difficult. In order to save the data it must be copied into non-volatile memory, which is usually the hard drive. If this step is not performed correctly it will hinder the investigation rather than aid it.

Although volatile memory unarguably has the potential of containing data significant to cases, the lack of a reliable technique to collect it without disturbing the hard drive has prevented its inclusion in most investigations. For instance, during an incident evidence could have been written to the hard drive and then deleted. In an effort to be as efficient as possible, operating systems generally mark these areas on a disk as “deleted” but do not bother to actually remove the data that is present. To do so is viewed as a time consuming and unnecessary operation since any new data placed in the space will overwrite the data previously marked as “deleted”. Forensics experts take advantage of this characteristic by using software to recover or “undelete” the data. The deleted information will be preserved as long as nothing is written to the same location on disk. This becomes important to the collection of volatile memory because simply writing it out to the hard drive could potentially overwrite this information and destroy critical evidence.

There are essentially four major components of computer forensics: collection, preservation, analysis, and presentation. Collection focuses on obtaining the digital evidence in a pure and untainted form. Preservation refers to the storage of this evidence using techniques that are guaranteed not to corrupt the collected data or the surrounding crime scene. Analysis describes the actual examination of the data along with the determination of applicability to the case. Presentation refers to the portrayal of evidence in the courtroom, and can be heavily dependent on the particular venue.

Accordingly to evidentiary rules, computer forensics falls under the broad category of “scientific evidence”. This category of evidence may include such things as expert testimony of a medical professional, results of an automated automobile crash test, etc. Rules governing the admittance of this category of evidence can vary based on jurisdiction and venue. The stringent Frye test, as articulated in Frye v. United States, 293 F. 1013 (D.C. Cir. 1923) is the basis for some current state law and older federal case law. According to the Frye test for novel scientific evidence, the proponent of scientific testimony must show that the principle in question is generally accepted within the relevant scientific field. This essentially requires all techniques to be made “popular” with peers though publications and presentations prior to its acceptance in court. This is generally sufficient for acquisition techniques that have been in existence for many years, but it does not allow for the inclusion of evidence gathered through new and novel procedures. Considering the fast pace of technology and the limited time to gain general acceptance, this plays an integral role in computer forensics cases. In the early nineties the Frye test was repeatedly challenged.

New federal guidelines were eventually established in 1993 by the Supreme Court in Daubert v. Merrell Dow Pharmaceuticals, Inc., 509 U.S. 579, 113 S.Ct. 2786, 125 L.Ed.2d 469 (1993) which adopted a more accommodating and practical approach for the admission of expert testimony in federal cases, including scientific evidence in the form of computer forensics cases.

According to the Daubert test, before a federal trial court will admit novel scientific evidence based on a new principle or methodology, the trial judge must determine at the outset whether the expert is proposing to testify to scientific knowledge that will assist the trier fact to understand or determine a fact in issue. This entails a preliminary assessment of whether the reasoning or methodology underlying the testimony is scientifically valid and can properly be applied to the facts in issue. The court may then consider additional factors, such as the following, prior to introduction of the evidence: (1) whether the theory or technique has been tested, (2) whether it was subjected to peer review or publication, (3) whether it is generally accepted within the relevant scientific community, or (4) whether it has a known or potential rate of error.

Related work in the field of computer forensics has primarily been focused on the collection of evidence from non-volatile memory such as hard drives. The UNIX operating system, however, does offer a few utilities that are capable of collecting copies of all volatile memory. These programs are commonly referred to as “crash dump” utilities and are generally invoked following a serious bug or memory fault. In some cases they can be invoked manually, but they typically write their results out to the hard drive of the system, and often require a reboot following their usage. Their focus is that of debugging so they are of little use to forensics efforts. These methods operate by storing an entire copy of all volatile memory on the hard drive. They would require the development of a special utility to traverse the data and “recreate” process tables, etc to determine what programs were running. In addition, because this data is written to the hard drive it potentially destroys “deleted” files still present.

Accordingly, it can also be appreciated that a more robust approach is needed to collect forensic evidence associated computer system compromises, such that improved procedures can be implemented by appropriate personnel to aid criminal investigation and prosecution proceedings.

### Operating System Recovery

The continual creation of new and unproven software inevitability produces exploitable flaws and vulnerabilities. Because these flaws are unpredictable, prevention techniques such as those based on predetermined signatures do not provide adequate protection. Defensive mechanisms should ultimately be paired with practical remediation techniques to provide the greatest results. Current computer network protection techniques such as firewalls and intrusion detection systems are similar to what the human body provides as perimeter defense mechanisms. For instance, the skeleton protects precious organs, layers of skin protect inner networks of nerves and vessels, and multiple flushing mechanisms protect against dangerous bacteria. However, the human body does not stop at perimeter protection as computer security does. It implements the notion of defense in depth and offers many additional layers of protection. Specifically it provides a key element that computer network protection does not—an immune and healing system. What the human body cannot prevent it can actually heal and recover from. Nature has conceded to the notion that not all outside attacks are preventable, as should operating system developers and security architects.

The most powerful method of operating system protection undoubtedly occurs when the administrator conducts an initial baseline following a trusted installation, installs a powerful prevention system that is capable of sensing attacks as they occur, and frequently updates the baseline according to each change on the system. As stated above, this model is unfortunately not always applicable to all systems because many administer systems that have been previously installed, and the workload of constant baselining can quickly become overwhelming and unpractical. It is also difficult to convince many of the importance of dedicating security resources to a system prior to any incidents. To date, the standard technique for recovery without a trusted baseline is to re-install the entire operating system. This method is costly, time consuming, and destroys critical forensic evidence. It appears that most other “recovery” methodologies are conducted by first turning the computer off and physically analyzing files on the hard drive.

Despite one's best efforts, current remediation/self-healing techniques also have inherent limitations. Because the action of self-healing occurs completely after the fact of the incident, there is no way of knowing exactly what actions the attacker took before the self-healing occurred. The attacker may have triggered an entire chain of events that cannot be recovered from because the past cannot be changed. For instance, once the attacker gained root access on the operating system, they may have accessed sensitive user names and passwords that they can use to leverage for additional access, or they may have altered critical numbers within a sensitive database. Without prior installation or baselining before the attack, there is no means of identifying that this exposure has taken place. In addition, the attacker may have permanently overwritten critical components of the operating system that can only be recovered with restoration from a back up or re-installation. These known drawbacks, thus, give rise to a further need to provide an improved and more intuitive approach to operating system restoration following an exploit.

Aside from the separate needs noted above for improving upon known aspects of exploitation detection, forensics data collection and operating system restoration, there remains a more global need to integrate these heretofore isolated techniques in a manner which is yet to be recognized in the industry, thus providing a more comprehensive solution to security needs.

### BRIEF SUMMARY OF THE INVENTION

In its various embodiments, the present invention relates to a computer security system, a computer readable medium, a security software product, and a computerized method. The computer security system comprises both volatile and non-volatile memory, and a processor that is programmed to detect exploitation of a computer operating system which is of a type that renders the computer insecure. At least one of two responses is initiated upon detection of the exploitation. One response entails collecting forensics data characteristic of the exploitation, and another entails restoring in the operating system to a pre-exploitation condition.

A computer can be considered “secure” if its legitimate user can depend on the computer and its software to behave as expected. Accordingly, an “exploitation” or “compromise”, in the context of the present invention, can be regarded as any activity affecting the operating system of the computer, whether or not known to the legitimate user, which renders the computer insecure such that it no longer behaves as expected. Exploits and compromises can manifest in many ways, of which a rootkit installation is only one representative example. In addition, there can be one or a plurality of indicators of an exploitation, depending on the circumstances, so that an occurrence of the exploitation is deemed to encompass any detectible manifestation of it.

Advantageously, the system may also comprise a storage device, such as a removable, external flash drive, although the system can write out to any device which has suitable storage capacity. To this end, the storage device could be an internal hard drive, an external hard drive of another computer located elsewhere on the network, a pda, an mp3 player, etc. Thus, references made herein to any particular storage device are for illustrative purposes.

Where the response entails collecting forensics data, the forensics data may be transferred for storage onto the removable storage device. Collection of forensics data does not necessarily entail transfer and storage, although the storage on an external device is preferred. It is preferred to collect the forensics data without utilizing the resources of the non-volatile memory, and in a manner which preserves integrity of both volatile and non-volatile memory data. During collection, it may be desirable to preliminarily halt all unnecessary processes on the computer and remount all drives associated with the non-volatile memory. It may also be desirable to halt the CPU once the targeted evidence (i.e. the forensics data) is collected. While these steps can be performed to preserve the integrity of the hard drive, they are optional since there could certainly be situations, such as a offensive data collection situation, in which it is not desirable to halt these things.

The security system is particularly suited for detecting exploitations, such as hidden kernel modules, hidden system call patches, hidden processes and hidden files. Hidden port listeners can also be detected. Where the response to detection of the exploitation involves restoration of the operating system, this can be accomplished by removing any hidden kernel modules, any hidden system call patches, any hidden files and terminating any hidden processes which have been detected.

The computer-readable medium of the present invention has executable instructions for performing a method which comprises detecting exploitation of an operating system which renders the computer insecure, and initiating a response to enable transfer of data characteristic of the exploitation onto a removable storage device, or restore the operating system to a pre-exploitation condition, or both. Another embodiment of the computer-readable medium is for use with a host computer that includes an associate operating system, non-volatile memory and volatile memory. The computer readable medium has executable instructions for performing a method comprising (1) detecting an occurrence of exploitation to the operating system which renders the host computer insecure (2) collecting, from the volatile memory, forensics data that is characteristic of the exploitation, (3) transferring the forensics data onto a removable storage device in a manner which ensures integrity of other data residing in the non-volatile memory, and (4) restoring the operating system to a pre-exploit condition. The executable instructions may perform according to the advantages mentioned above for the computer security system and may be accomplished by a plurality of interfaced, loadable kernel modules which, collectively, contain the executable instructions.

The security software product of the invention is for use on a host computer, such as one running Linux operating system, to monitor for and response to activity corresponding to rootkit exploitation rendering the host computer insecure. The security software product, according to one embodiment, comprises computer readable media having a suite of integrated software components adapted to interface with one another. These components include (1) an exploitation detection component having executable instructions for detecting the activity corresponding to the rootkit exploitation, (2) a forensics data collection component interfaced with the exploitation detection component, for collecting forensics data characteristic of the rootkit exploitation so that it may be transferred to a removable storage device, (3) an OS restoration component interfaced with the exploitation component for restoring operating system to a secure condition in response to detection of the activity.

According to another embodiment of the security software product, the integrated software components are provided on a common medium and include a plurality of loadable kernel modules which are interfaced to, respectively, accomplish exploitation detection, forensics data collection, and OS restoration. In addition to providing the preferred advantages discussed above in connection with the other embodiments, the security software product, and particularly its exploitation detection component, is particularly suited for detecting both signature-based and non-signature-based rootkit activity.

Finally, a computerized method is provided and comprises monitoring activity within a computer's operating system in order to detect the occurrence of an exploitation. Thereafter, forensics data collection and/or operating system restoration is performed, as noted above. If forensics data collection is performed, it is preferably accomplished in a manner which preserves integrity of characteristic information stored in both volatile and non-volatile memory resources on the computer. It is particularly preferred to collect forensics data located within the volatile memory resources, so that it is not lost if the computer is subsequently shutdown.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 represents a high level diagrammatic view of an exemplary security software product according to the present invention;

FIG. 2 represents a high level flow chart for computer software which implements the exemplary functions of the computer security system, security software product, and computer-readable medium of the present invention;

FIG. 3 is a high level flow chart diagrammatically illustrating the principle features for the exploitation detection component of the invention;

FIG. 4 is a high level flow chart for computer software which implements the functions of the exploitation detection component's kernel module;

FIG. 5 is a high level diagrammatic view, similar to FIG. 1, for illustrating the integration of the detection component's various detection models into the overall software security system;

FIG. 6(a) is a prior art diagrammatic view illustrating an unaltered linked list of kernel modules;

FIG. 6(b) is a prior art diagrammatic view illustrating the kernel modules of FIG. 6(a) after one of the modules has been removed from the linked list using a conventional hiding technique;

FIG. 7 is a block diagram representing the physical memory region of an exploited computer which has a plurality of loadable kernel modules, one of which has been hidden;

FIG. 8 represents a flow chart for computer software which implements the functions of the hidden module detection routine that is associated with the exploitation detection component of the present invention;

FIG. 9 is a diagrammatic view for illustrating the interaction in the Linux OS between user space applications and the kernel;

FIGS. 10(a)-10(d) collectively comprise a flow chart for computer software which implements the functions of the exploitation detection component's routine for detecting hidden system call patches;

FIG. 11 is tabulated view which illustrates, for representative purposes, the ranges of address which were derived when the hidden system call patches detection routine of FIG. 10 was applied to a computer system exploited by the rootkit Adore v0.42;

FIG. 12 is a functional block diagram for representing the hidden process detection routine associated with the exploitation component of the present invention;

FIG. 13 represents a flow chart for computer software which implements the functions of the hidden process detection routine;

FIG. 14 represents a flow chart for computer software which implements the functions of the process ID checking subroutine of FIG. 13;

FIG. 15 is a functional block diagram for representing the hidden file detection routine associated with the exploitation component of the present invention;

FIG. 16 represents a flow chart for computer software which implements the functions of the hidden file detection routine;

FIG. 17 represents a flow chart for computer software which implements the file checker script associated with the exploitation detection component of the present invention;

FIG. 18 is a functional block diagram for representing the port checker script associated with the exploitation component of the present invention;

FIG. 19 represents a flow chart for computer software which implements the port checker script;

FIGS. 20(a)-20(d) are each representative output results obtained when the exploitation detection component described in FIGS. 3-19 was tested against an unexploited system (FIG. 20(a)), as well a system exploited with a user level rootkit (FIG. 20(b)) and different types of kernel level rootkits (FIGS. 20(c) & (d));

FIG. 21 is a high level flow chart diagrammatically illustrating the principle features for the forensics data collection component of the invention;

FIG. 22(a) is a high level flow chart for computer software which implements the functions of the kernel module for the forensics data collection component;

FIG. 22(b) illustrates a representative main report page for the forensics data collection component which can be generated to provide conveniently links to various results output;

FIG. 23 represents a flow chart for computer software which implements the functions of the process freezing routine that is associated with the forensics data collection component of the present invention;

FIG. 24 represents a flow chart for computer software which implements the functions of the file system re-mounting routine that is associated with the forensics data collection component;

FIG. 25(a) represents a flow chart for computer software which implements the functions of the module collection routine associated with the forensics data collection component;

FIG. 25(b) illustrates a representative output report page which could be generated to visually tabulate results obtained for the module collection routine;

FIG. 26 represents a flow chart for computer software which implements the functions of the memory analysis subroutine that is called within the module collection routine of FIG. 25(a);

FIG. 27(a) represents a flow chart for computer software which implements the functions of the system call table collection routine associated with the forensics data collection component;

FIG. 27(b) illustrates a representative output report page which could be generated to visually tabulate results obtained for the system call table collection routine;

FIG. 28(a) represents a flow chart for computer software which implements the functions of the kernel collection routine associated with the forensics data collection component;

FIG. 28(b) illustrates a representative output report page which could be generated to visually tabulate results obtained for the kernel collection routine;

FIG. 28(c) represents a flow chart for computer software which implements the function for copying the running kernel associated with the forensics data collection component;

FIG. 29(a)-(h) collectively comprise a flow chart for computer software which implements the functions of the process collection routine, and its associated subroutines, for the forensics data collection component;

FIG. 29(i) illustrates a representative output report page which could be generated to visually tabulate results obtained for the process collection routine;

FIG. 30(a) shows, for representative purposes, an example of some images that can be collected according to the image collection subroutine of FIG. 29(b);

FIG. 30(b) shows, for representative purposes, results which might be displayed when the file descriptors are obtained for one of the process IDs shown if FIG. 30(a);

FIG. 30(c) shows, for representative purposes, an example of a recovered environment listing;

FIG. 30(d) shows, for representative purposes, an example of a recovered mount listing;

FIG. 30(e) shows, for representative purposes, a status summary recovered from a command line;

FIG. 31 is a high level flow chart diagrammatically illustrating the principle features for the OS restoration component of the invention;

FIG. 32 is a high level flow chart for computer software which implements the functions of the kernel module for the OS restoration component;

FIG. 33 represents a flow chart for computer software which implements the functions of the system call table recovery routine that is associated with the OS restoration component of the present invention;

FIG. 34 represents a flow chart for computer software which implements the functions of the hidden process recovery routine that is associated with the OS restoration component;

FIG. 35 represents a flow chart for computer software which implements the functions of the hidden files recovery routine that is associated with the OS restoration component; and

FIGS. 36(a)-(g) are each representative output results obtained when the OS restoration component described in FIGS. 31-35 was applied against an unexploited system (FIG. 36(a)), as well a system exploited with the Adore kernel level rootkit (FIGS. 36(b)-(g));

### DETAILED DESCRIPTION OF THE INVENTION

### I. Introduction

In its various exemplary embodiments, this invention introduces a plurality of components which may be used as part of a computer security system, a software security product, a computer-readable medium, or a computerized methodology. An exploitation detection component, which operates based on immunology principles, conducts the discovery of compromises such as rootkit installations. As discussed in the Background section, selecting either positive or negative detection entails a choice between the limitation of requiring a baseline prior to compromise, or being unable to discover new exploits such as rootkits. Rather than relying on static file and memory signature analysis like other systems, this model is more versatile. It senses anomalous operating system behavior when activity in the operating system deviates, that is fails to adhere to, a set of predetermined parameters or premises which dynamically characterize an unexploited operating system of the same type. The set of parameters, often interchangeably referred to herein as “laws” or “premises”, may be a single parameter or a plurality of them. Thus, this aspect of the invention demonstrates a hybrid approach that is capable of discovering both known and unknown rootkits on production systems without having to take them offline, and without the use of previously derived baselines or signatures. The exploitation detection component of the system preferably relies on generalized, positive detection of adherence to defined “premises” or “laws” of operating system nature, and incorporates negative detection sensors based on need. The exploitation detection is further capable of interfacing with other components to collect forensics evidence and restore a computer system to a pre-compromise condition. Because the system is designed to operate while the computer is functioning online as a production server, performance impact is minimal. Moreover, the invention can be ported to virtually any operating system platform and has been proven through implementation on Linux. An explanation of the Linux operating system is beyond the scope of this document and the reader is assumed to be either conversant with its kernel architecture or to have access to conventional textbooks on the subject, such as Linux Kernel Programming, by M. Beck, H. Böhme, M. Dziadzka, U. Kunitz, R. Magnus, C. Schroter, and D. Verworner., 3^{rd} ed., Addison-Wesley (2002), which is hereby incorporated by reference in its entirety for background information.

In the following detailed description, reference is made to the accompanying drawings which form a part hereof, and in which is shown by way of illustrations specific embodiments for practicing the invention. The leading digit(s) of the reference numbers in the figures usually correlate to the figure number, with the exception that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer operating systems, namely Linux, and software programming. Other terms will perhaps be more familiar to those conversant in the areas of intrusion detection, computer forensics and systems repair/maintenance. While the description to follow may entail terminology which is perhaps tailored to certain OS platforms or programming environments, the ordinarily skilled artisan will appreciate that such terminology is employed in a descriptive sense and not a limiting sense. Where a confined meaning of a term is intended, it will be set forth or otherwise apparent from the disclosure.

In one of its forms, the present invention provides a computer security system that is implemented on a computer which typically comprises a random access memory (RAM), a read only memory (ROM), and a central processing unit (CPU). One or more storage device(s) may also be provided. The computer typically also includes an input device such as a keyboard, a display device such as a monitor, and a pointing device such as a mouse. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA, network device or the like, which has the minimum architecture needed to accommodate the functionality of the invention. Moreover, the computer-readable medium which contains executable instructions for performing the methodologies discussed herein can be a variety of different types of media, such as the removable storage devices noted above, whereby the software can be stored in an executable form on the computer system.

The source code for the software was developed in C on an x86 machine running the Red Hat Linux 8 operating system (OS), kernel 2.4.18. The standard GNU C compiler was used for converting the high level C programming language into machine code, and Perl scripts where also employed to handle various administrative system functions. However, it is believed the software program could be readily adapted for use with other types of Unix platforms such as Solaris®, BSD and the like, as well as non-Unix platforms such as Windows® or MS-DOS®. Further, the programming could be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

A security software product embodying the present invention may be distributed in known manners, such as on computer-readable medium or over an appropriate communications interface so that it can be installed on the user's computer. Furthermore, alternate embodiments which implement the invention in hardware, firmware or a combination of both hardware and firmware, as well as distributing the software components and/or the data in a different fashion will be apparent to those skilled in the art. It should, thus, be understood that the description to follow is intended to be illustrative and not restrictive, and that many other embodiments will be apparent to those of skill in the art upon reviewing the description.

### II. Security Software Suite

With the above in mind, one exemplary embodiment of the present invention provides a security software product which preferably comprises a plurality of software components for use in: (1) detecting computer system exploitation(s), namely those primarily affecting the operating system's kernel; (2) collecting information characteristic of the exploit(s); and (3) restoring the system to a pre-exploitation condition. Any two or more of the components described herein can comprise the security software product, although it is preferred to employ all three. Further, the particular combination of components may be integrated into a single programming architecture (i.e. software package) and reside permanently within a host computer system to run dynamically as needed. Alternatively, they may be implemented as non-integrated components executing at different times depending on the particular circumstances.

The invention has been employed by the inventors utilizing the development tools discussed above, and implemented in a modularized design. That is, each of the three software components has been coded as a separate module which is compiled and dynamically linked and unlinked to the Linux kernel on demand at runtime through invocation of the init_module( ) and cleanup_module( ) system calls. Further, provisions have been made for the exploitation detection and forensics components/modules to execute integrally as a collective group via a suitable interface that is governed by user-defined parameters. As stated above, Perl scripts are used to handle some of the administrative tasks associated with execution, as well as some of the output results.

The ordinarily skilled artisan will recognize that the concepts of the present invention are virtually platform independent. Further, it is specifically contemplated that the functionalities described herein can be implemented in a variety of manners, such as through direct inclusion in the kernel code itself, as opposed to one or more modules which can be linked to (and unlinked from) the kernel at runtime. Thus, the reader will see that the more encompassing term “component” or “software component” are sometimes used interchangeably with the term “module” to refer to any appropriate implementation of programs, processes, modules, scripts, functions, algorithms, etc. for accomplishing these capabilities. Furthermore, the reader will see that terms such, “program”, “algorithm”, “function”, “routine” and “subroutine” are used throughout the document to refer to the various processes associated with the programming architecture. For clarity of explanation, attempts have been made to use them in a consistent hierarchical fashion based on the exemplary programming structure. However, any interchangeable use of these terms, should not be misconstrued as limiting since that is not the intent.

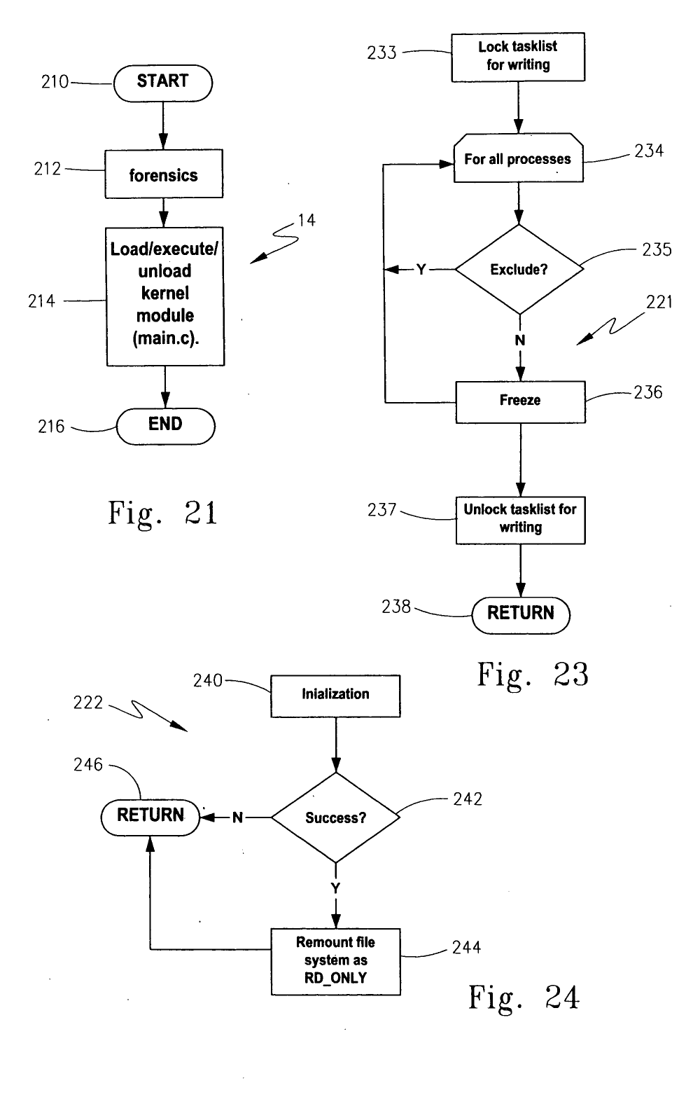

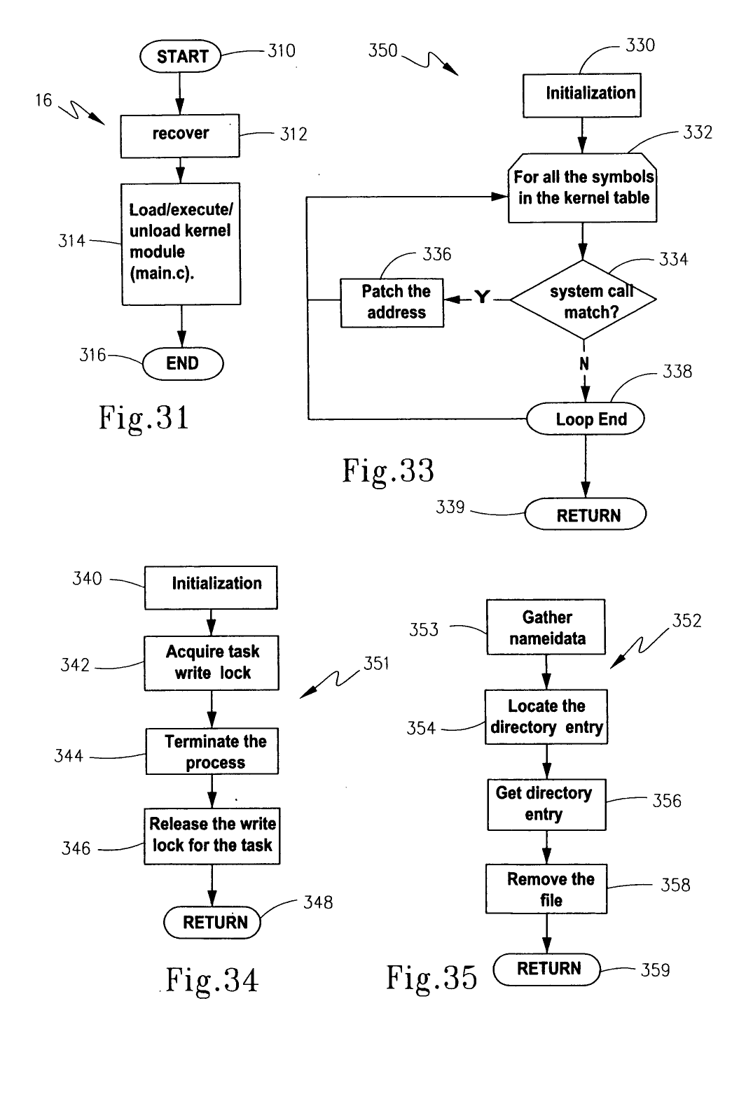

With the above in mind, initial reference is made to FIG. 1 which is a high-level diagrammatic view introducing an embodiment of the security software product 10 according to the invention. Security software product 10 preferably incorporates a combination of software components each of which may be coded as a module onto computer-readable media and dynamically linked to the kernel at runtime. A first software component is in the form of an exploitation detection module 12 which is preferably responsible for detecting a set of exploits (i.e. one or more), including hidden kernel modules, operating system patches (such as to the system call table), and hidden processes. This module also generates a “trusted” file listing for comparison purposes. The exploitation detection module is discussed in detail below with reference to FIGS. 3-20(d). A second software component is in the form of forensics module 14 that is preferably responsible for collecting forensics data on the exploits, as well as other information pertaining to the kernel itself and dynamic memory. This module is discussed in detail below with reference to FIGS. 21-30(e). A third software component is in the form of an operating system (OS) restoration module 16 which is discussed below in FIGS. 31-36(g). This component is responsible for recovering the OS and returning it to a pre-exploitation condition. One or more interfaces 18 are provided so that two or more of the software components can execute in conjunction as determined by user preferences. Of course, the ordinarily skilled artisan will appreciate that each of these modules can work separately. That is, for example, the forensics module 14 may be used to collect forensics data for an exploited system, whether or not those exploits are detected by exploitation detection module 12 discussed herein or through some other detection scheme. The same holds true for the OS restoration module 16. While the present invention is suitably directed to integration of two or more (i.e. a suite) of these software components, it is the intention to devote future applications to them separately.

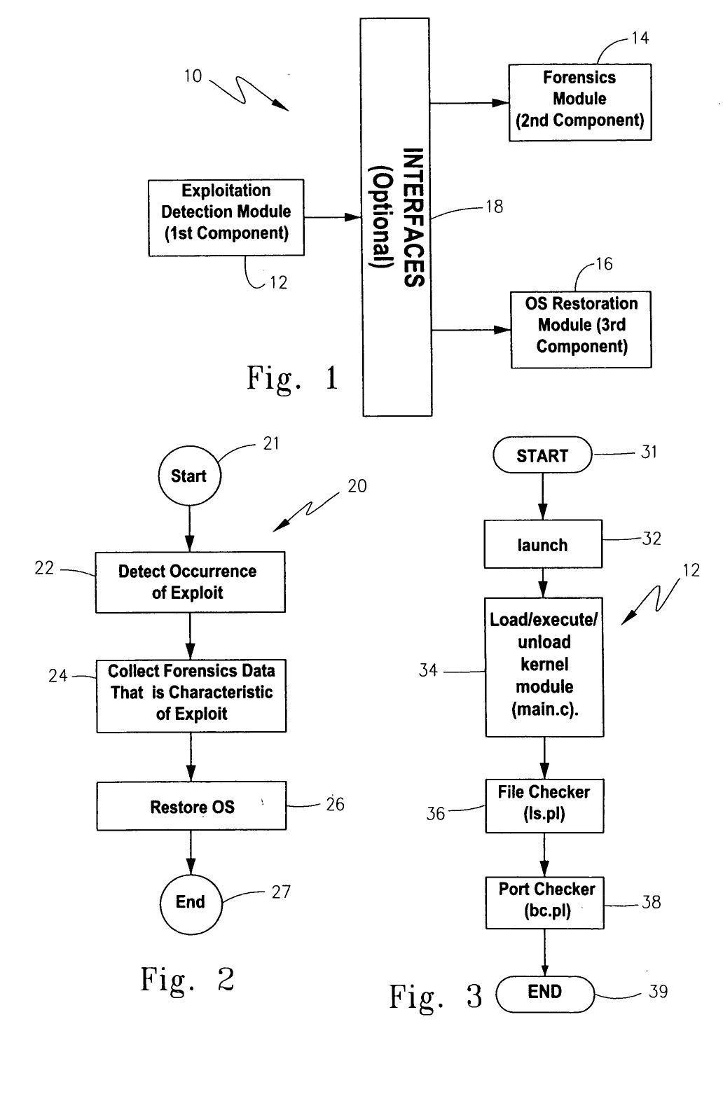

FIG. 2 shows a high level flowchart for computer software which implements the functions of a computerized method according to the invention. FIG. 2 contemplates the provision of a security software package having a plurality of integrated software components, such as the various modules described herein, for assessing an exploitation of a computer via a methodology 20 shown in FIG. 2. Following start at 21, methodology 20 initially detects at 22 an occurrence of the exploitation, which may be the result of a single anomaly associated with the computer or a plurality of anomalies. Once the exploitation is detected, forensics data is collected at 24 to obtain information that is characteristic of the exploitation. Thereafter, the computer's operating system is restored at 26 to a pre-exploitation condition. Methodology 20 terminates at 27.

Having briefly introduced in FIGS. 1 & 2 the software security system 10 and corresponding methodology 20 which are contemplated by the present invention, reference will now be made to the remaining figures to describe in detail the functionality of the various software components and their interrelationships.

### A. Exploitation Detection Component

The exploitation detection component primarily focuses on protecting the most sensitive aspect of the computer, its operating system. In particular it presents an approach based on immunology to detect OS exploits, such rootkits and their hidden backdoors. Unlike current rootkit detection systems, this model is not signature based and is therefore not restricted to identification of only “known” rootkits. In addition this component is effective without needing a prior baseline of the operating system for comparison. Furthermore, this component is capable of interfacing with the other modules discussed below for conducting automated forensics and self-healing remediation as well.

Differentiating self from non-self is a critical aspect for success in anomaly detection. Rather than relying on pre-compromise static training (machine learning) like other research, one can instead generalize current operating system behaviors in such a way that expectations are based on a set of pre-determined operating system parameters (referred to herein as fundamental “laws” or “premises”), each of which corresponds to a dynamic characteristic of an unexploited operating system. Unlike errors introduced during machine learning, changes in behavior based on operating premises lead to true anomalies. Therefore, false positives are limited to race conditions and other implementation errors. In addition, false positives are absent because of the conservative nature of the laws.

Through the use of independent, but complementary sensors, the exploitation detection component identifies erroneous results by unambiguously distinguishing self from non-self, even though the behaviors of each may change over time. Rather than selecting one single method (i.e. positive or negative detection) for this model, the exploitation detection component leverages the complimentary strengths of both to create a hybrid design. Similar to the biological immune system, generalization takes place to minimize false positives and redundancy is relied on for success.

This component begins by observing adherence to the following fundamental premises, using positive detection. Once a deviation has been identified, the component implements negative detection sensors to identify occurrences of pathogens related to the specific anomaly:
Premise 1: All kernel calls should only reference addresses located within normal kernel memory.
Premise 2: Memory pages in use indicate a presence of functionality or data.
Premise 3: A process visible in kernel space should be visible in user space.
Premise 4: All unused ports can be bound to.
Premise 5: Persistent files must be present on the file system media.
   Thus, an operating system can be monitored to ascertain if its behavior adheres to these “premises” or predetermined operating system parameters. As such, a deviation from any one of these requirements indicates an occurrence of anomalous activity, such as the presence of either an application or kernel level exploitation that is attempting to modify the integrity of the operating system by altering its behavior. The exploitation detection component is preferably composed of a loadable kernel module (LKM) and accompanying scripts. It does not need to be installed prior to operating system compromise, but installation requires root or administrator privileges. To preserve the original file system following a compromise, the module and installation scripts can be executed off of removable media or remotely across a network.

Initial reference is made to FIG. 3 which shows a high-level flowchart for diagrammatically illustrating exploitation detection component 12. When the exploitation detection component 12 is started at 31, a prototype user interface 32 is launched. This is a “shell” script program in “/bin/sh”, and is responsible for starting the three pieces of exploitation detection component 12, namely, exploitation detection kernel module (main.c) 34, file checker program (ls.pl) 36 and port checker program (bc.pl) 38. The kernel module 34 is loaded/executed and then unloaded. This is the primary component of the exploitation detection component 12 and is responsible for detecting hidden kernel modules, kernel system call table patches, hidden processes, and for generating a “trusted” listing of file that is later compared by file checker 36. File checker 36 may also be a script that is programmed in Perl, and it is responsible for verifying that each file listed in the “trusted” listing generated by kernel module 34 is visible in user space. Anything not visible in user space is reported as hidden. Finally, port checker 38 is also executed as a Perl script. It attempts to bind to each port on the system. Any port which cannot be bound to, and which is not listed under netstat is reported as hidden. After each of the above programs have executed, the exploitation detection component ends at 39.

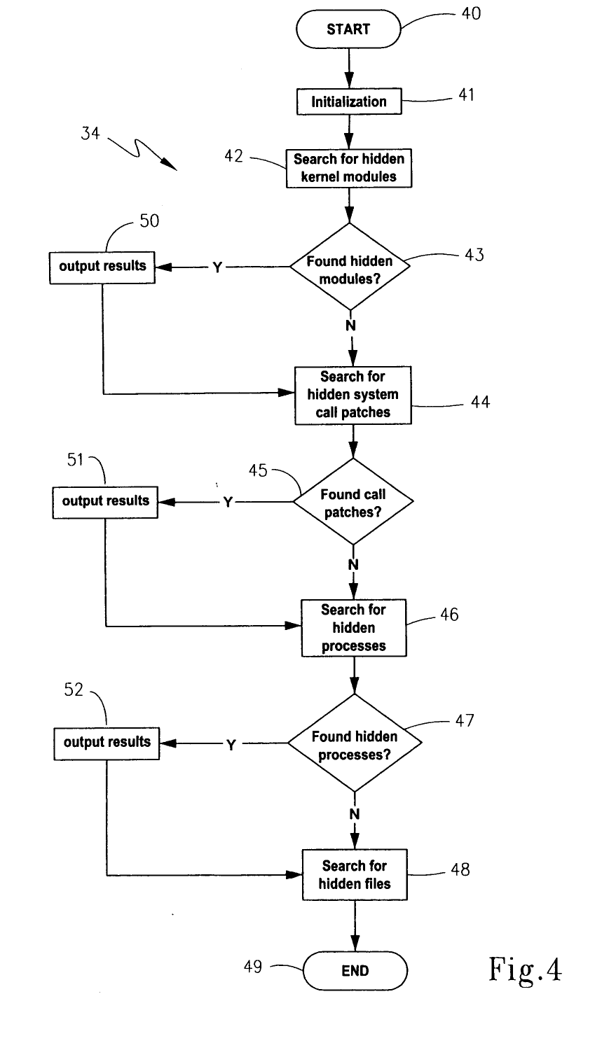

The program flow for kernel module 34 is shown in FIG. 4. Following start 40, an initialization 41 takes place in order to, among other things, initialize variables and file descriptors for output results. A global header file is included which, itself, incorporates other appropriate headers through #include statements and appropriate parameters through #define statements, all as known in the art. A global file descriptor is also created for the output summary results, as well as a reusable buffer, as needed. Modifications to the file descriptor only take place in _init and the buffer is used in order by functions called in n_it so there is no need to worry about making access to these thread safe. This is needed because static buffer space is extremely limited in the virtual memory portion of the kernel. One alternative is to kmalloc and free around each use of a buffer, but this creates efficiency issues. As for other housekeeping matters, initialization 41 also entails the establishment of variable parameters that get passed in from user space, appropriate module parameter declarations, function prototype declarations, external prototype declarations for the forensic data collection module, and establishment of an output file wrapper. This is a straightforward variable argument wrapper for sending the results to an output file. It uses a global pointer that is initially opened by _init and closed with _fini. In order to properly access the file system, the program switches back and forth between KERNEL_DS and the current (user) fs state before each write. It should be appreciated that the above initialization, as well as other aspects of the programming architecture described herein for this and other modules, is dictated in part, by the current proof of concept, working prototype status of the invention, and is not to be construed in any way as limiting. Indeed, other renditions such as commercially distributable applications would likely be tailored differently based on need, while still embodying the spirit and scope of the present invention.

Following initialization 31, a function is called to search at 42 the kernel's memory space for hidden kernel modules. If modules are found at 43, then appropriate output results 50 are generated whereby names and addresses of any hidden modules are stored in the output file. Whether or not hidden modules are found at 43, the program then proceeds at 44 to search for hidden system call patches within the kernel's memory. If any system call patches are found, their names and addresses are output at 51. Again, whether or not hidden patches are located, the program then proceeds to search for hidden processes at 46. If needed, appropriate output results are provided at 53, which preferably include a least the name and ID of any hidden processes. Finally, the kernel module 34 searches at 48 for hidden files 48 whereby a trusted list of all files visible by the kernel is generated. This trusted listing is subsequently compared to the listing of files made from user space (File checker 38 in FIG. 3). The program flow for kernel module 34 then ends at 49.

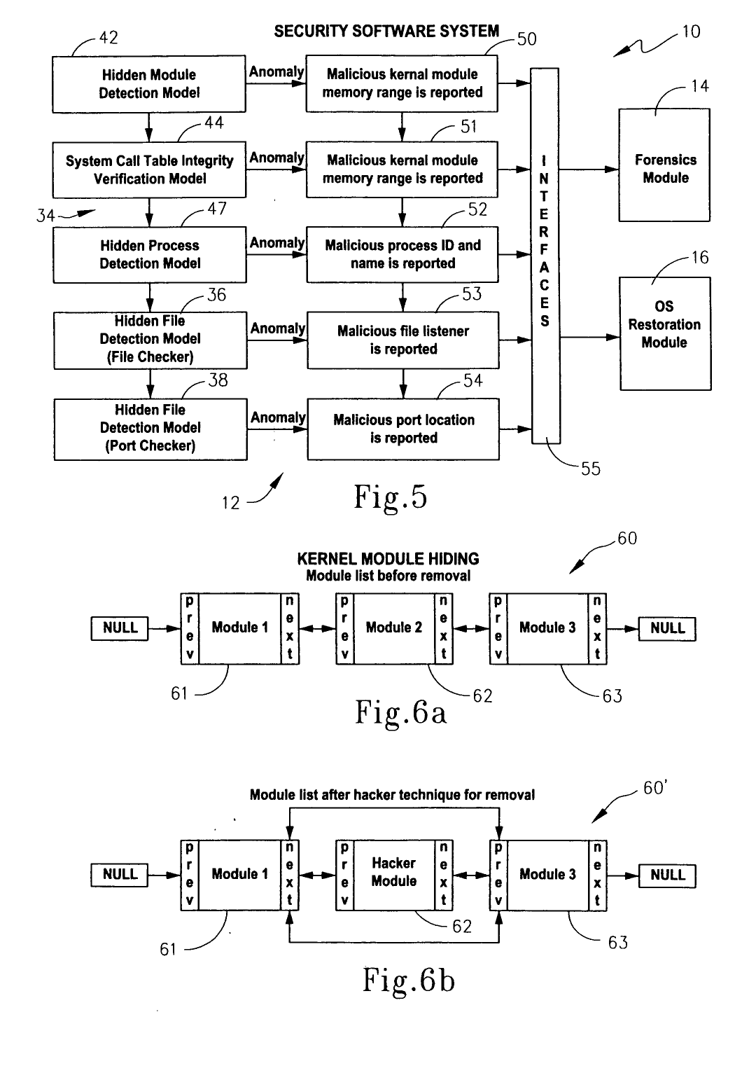

With an understanding of FIG. 4, the integration of the exploitation detection component's functionality into the overall security software product/system 10 of the invention can now be better appreciated with reference to FIG. 5. Each of the various detection models associated with exploitation detection component 12 preferably reports appropriate output results upon anomaly detection. Thus, if an anomaly is detected by hidden module detection model 42, the malicious kernel module memory range is reported which corresponds to the generation of output results 50 in FIG. 4. The same holds true for the system call table integrity verification model 44 and the hidden processes detection model 47 which, respectively, report any anomalies at 51 and 52. Any anomaly determined by hidden file detection model 36 or hidden port detection model 38 are, respectively, reported at 53 and 54. Appropriate interfaces 55 allow the malicious activity to be sent to the forensics module 14 and/or OS restoration module 16, as desired.

The various functions associated with kernel module 34 in FIG. 4 will now be discussed in greater detail. The first of these corresponds to the search for hidden modules 42 in FIG. 4. As kernel modules are loaded on the operating system they are entered into a linked list located in kernel virtual memory used to allocate space and maintain administrative information for each module. The most common technique for module hiding is to simply remove the entry from the linked list. This is illustrated in FIGS. 6(a) and 6(b). FIG. 6(a) illustrates a conventional module listing 60 prior to exploitation. Here, each module 61-63 is linked by pointers to each predecessor and successor module. FIG. 6(b), though, illustrates what occurs with the linked list when a module has been hidden. In FIG. 6(b), it may be seen that intermediate module 62 of now altered linked list 60′ has now been hidden such that it no longer points to predecessor module 61 or successor module 63. Removing the entry as shown, however, does not alter the execution of the module itself—it simply prevents an administrator from readily locating it. Thus, even though module 62 is unlinked, it remains in the same position in virtual memory because this space is in use by the system and is not de-allocated while the module is loaded. This physical location is a function of the page size, alignment, and size of all previously loaded modules. It is difficult to calculate the size of all previously loaded modules with complete certainty because some of the previous modules may be hidden from view. Rather than limiting analysis to “best guesses”, the system analyzes the space between every linked module.

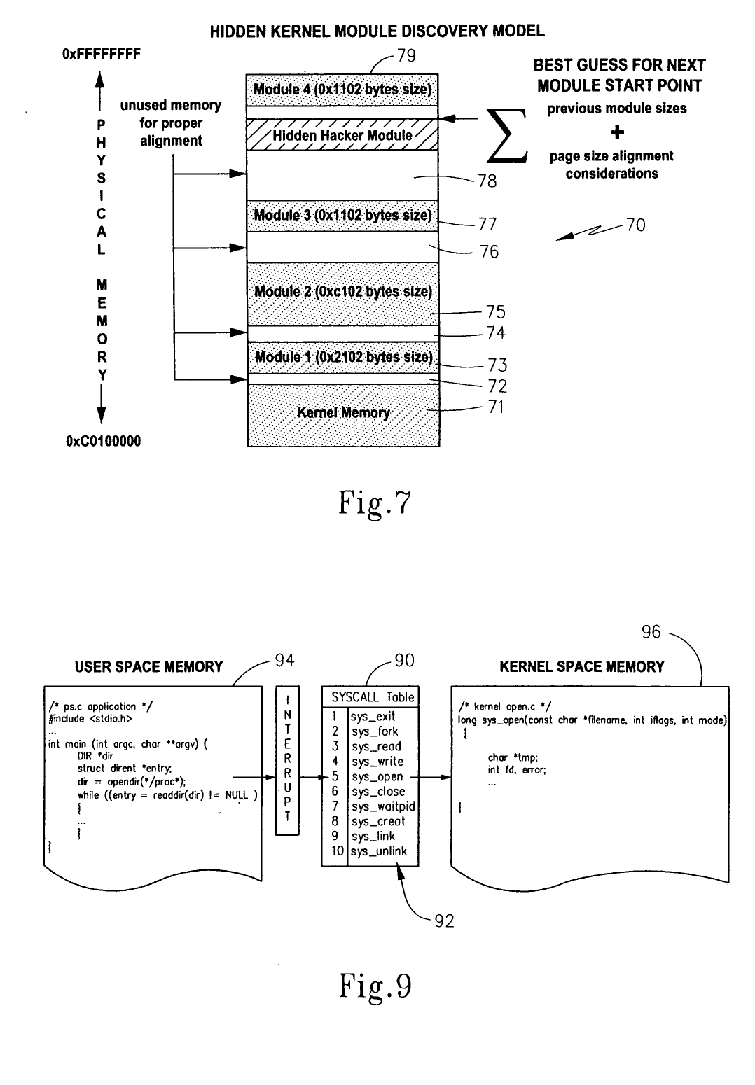

To more fully appreciate this, FIG. 7 illustrates various modules stored within a computer's physical memory 70. More particularly, a lower portion of the physical memory beginning at address 0xC0100000 is occupied by kernel memory 71. FIG. 7 shows a plurality of loadable kernel modules (LKMs) 73, 75, 77 and 79 which have been appended to the kernel memory as a stacked array. Each LKM occupies an associated memory region as shown. Unused memory regions 72, 74, 76 and 78 are interleaved amongst the modules and the kernel memory 71. This is conventional and occurs due to page size alignment considerations. Additionally, as also known, each module begins with a common structure that can be used to pinpoint its precise starting address within a predicted range. Thus, even without relying on the kernel's linked list, these predictable characteristics can be used to generate a trustworthy kernel view of loaded modules. In other words, insertion of any hidden hacker module, such as for example the hacker module surreptitiously inserted between modules 77 and 79 in FIG. 7, results in a determination of an abnormal address range between the end of module 77 and the beginning of module 79 (even accounting for page size alignment considerations).

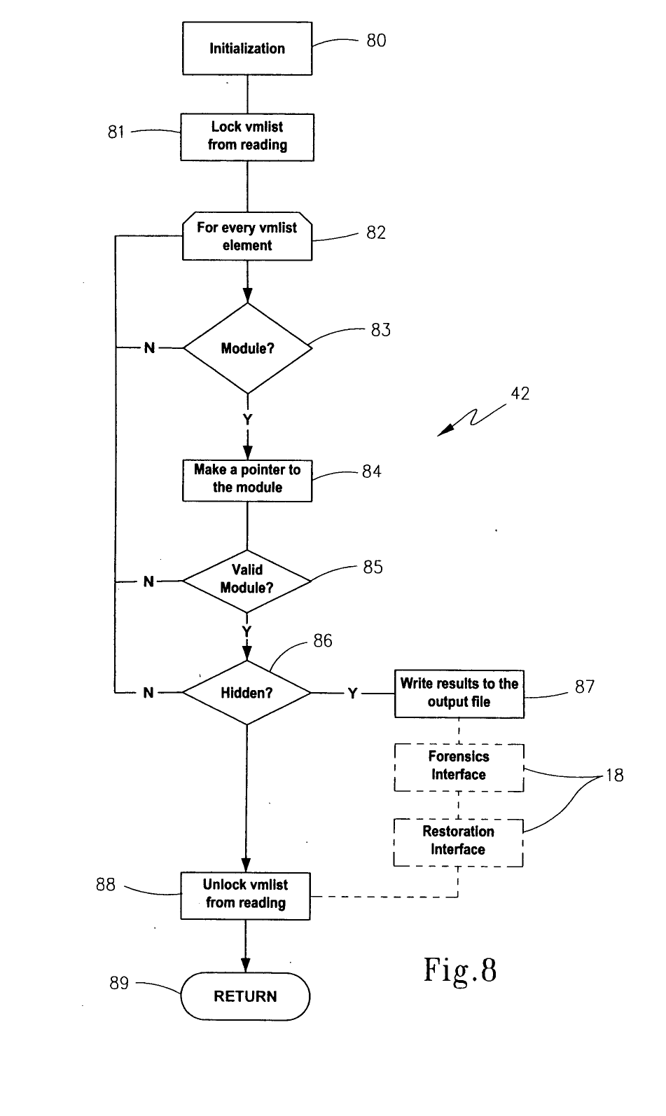

Recalling premise 2 from above that “memory pages in use indicate a presence of functionality or data” leads to a recognition that the computer's virtual memory can be searched page by page within this predicted range to identify pages that are marked as “active”. Since gaps located between the kernel modules are legitimately caused by page size alignment considerations, there should be no active memory within these pages. However, any active pages within the gaps that contain a module structure indicate the presence of a kernel implant that is loaded and executing, but has been purposefully removed from the module list. Accordingly, the exploitation detection component provides a function 42 for detecting hidden kernel modules, and the flow of its routine (see also FIG. 3, above) is shown in FIG. 8.

Function 42 is initiated via a function call within the loadable kernel module 34 (main c). Its analysis entails a byte-by-byte search for the value of sizeof(struct module) which is used to signal the start of a new module. This space should only be used for memory alignment and the location of data indications that a module is being hidden. During initialization 80, data structures and pointers necessary for the operation of this procedure are created. The starting point for the module listing is located and the read lock for the vmlist is acquired at 81. A loop is then initiated at 82 so that each element (i.e. page of memory) in the vmlist can be parsed. As each element is encountered, a determination is made as to whether the element has the initial look and feel of a kernel module. This is accomplished by ascertaining at 83 whether the element starts with the value sizeof(struct module), as with any valid Linux kernel module. If not, the algorithm continues to the beginning of the loop at 82 to make the same determination with respect to any next module encountered. If, however, the encountered element does appear to have characteristics of a valid kernel module, a pointer is made at 84 to what appears to be a module structure at the top of the memory page. A verification is then made at 85 to determine if pointers of the module structure are valid. If the pointers are not valid, this corresponds to data that is not related to a module and the algorithm continues in the loop to the next element at 82. If, however, the pointers of the module structure are valid then at 86, a determination is made as to whether the module is included in the linked list of modules, as represented by FIGS. 6(a) & (b). If so, then it is not a hidden module, and the function continues in the loop to the next element. However, if the module is not included in the linked list then it is deemed hidden at 86 and results are written to the output file at 87. These results preferably include the name of the module, its size, and the memory range utilized by the module. Optionally, appropriate calls can be made via interfaces 18 to appropriate functions associated with the forensics collection module 14 and the OS restoration module 16 in order to collect pertinent forensics data and recover pertinent aspects of the operating system from the detected hidden module exploitation. Thereafter, the function continues in the loop to the next element, if any. When all the elements in the vmlist have been analyzed, it is unlocked from reading at 88 and the function returns at 89.

It is contemplated by the inventors that the hidden module detection function 42 can be expanded in the future by incorporating the ability to search the kernel for other functions that reference addresses within the gaps that have been associated with a hidden kernel module (indicating what if anything the kernel module has compromised). Such an enhancement would further exemplify how the model can adapt from a positive detection scheme to a negative detection scheme based on sensed need. In essence, the model would still begin by applying a generalized law to the operating system behavior, and detect anomalies in the adherence to this law. When an anomaly is identified, the system could generate or adapt negative detectors to identify other instances of malicious behavior related to this anomaly.

Following hidden module detection, the next function performed by kernel module 34 ascertains the integrity of the system call table by searching the kernel for hidden system call patches. This corresponds to operation 44 in FIG. 4 and is explained in greater detail with reference now to FIGS. 9-11. As represented in FIG. 9, the system call table 90 is composed of an indexed array 92 of addresses that correspond to basic operating system functions. Because of security restrictions implemented by the x86 processor, user space programs are not permitted to directly interact with kernel functions for low level device access. They must instead rely on interfacing with interrupts and most commonly, the system call table, to execute. Thus, when the user space program desires access to these resources in UNIX, such as opening a directory as illustrated in FIG. 9, an interrupt 0x80 is made and the indexed number of the system call table 90 that corresponds to the desired function is placed in a register. The interrupt transfers control from user space 94 to kernel space 96 and the function located at the address indexed by the system call table 90 is executed. System call dependencies within applications can be observed, for example, by executing strace on Linux® or truss on Solaris®.

Most kernel level rootkits operate by replacing the addresses within the system call table to deceive the operating system into redirecting execution to their functions instead of the intended function (i.e., replacing the pointer for sys_open( ) in the example above to rootkit_open( ), or some other name, located elsewhere in memory). The result is a general lack of integrity across the entire operating system since the underlying functions are no longer trustworthy.

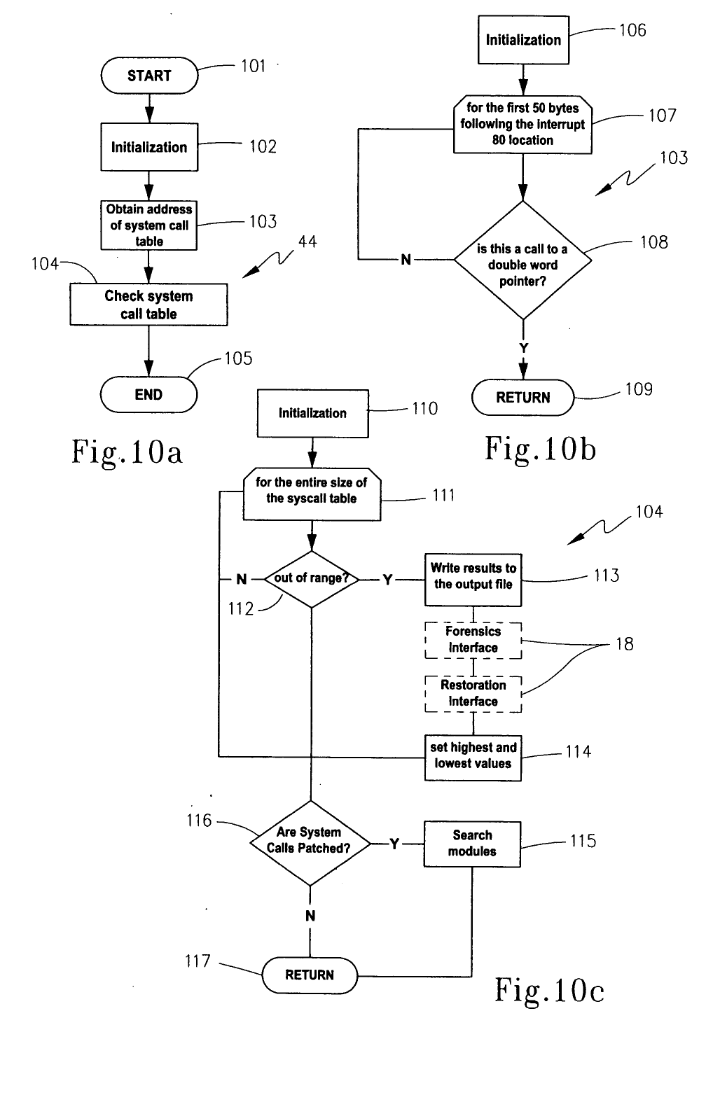

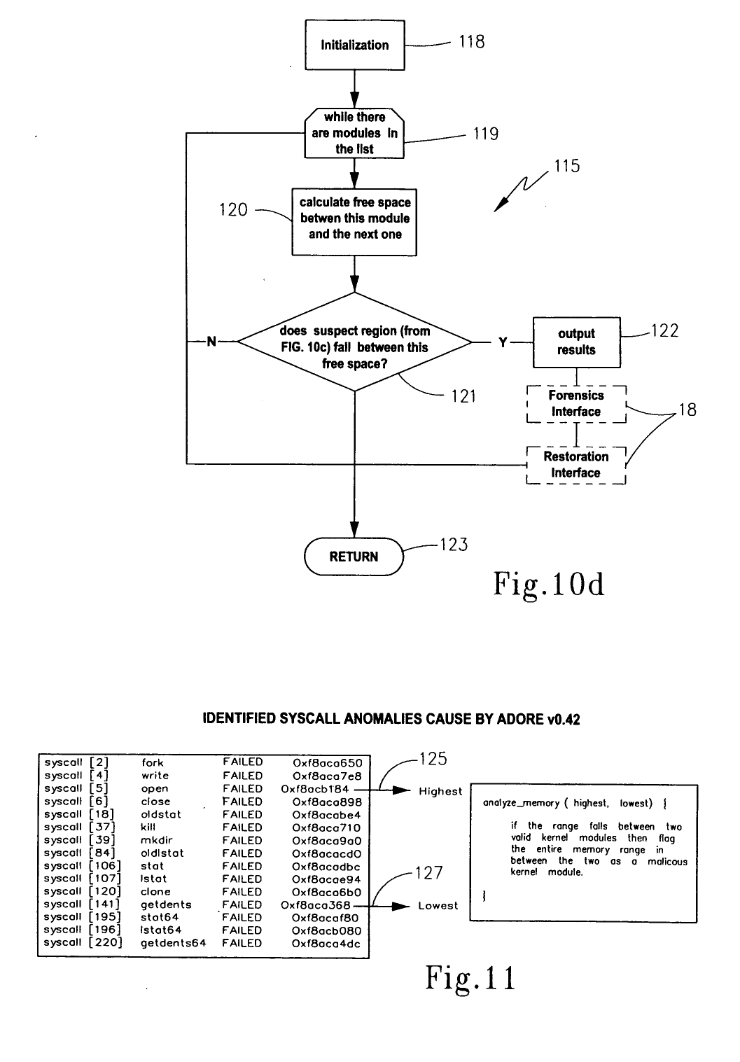

To explain detection of these anomalies in the system call table, reference is made to FIGS. 10(a)-10(d) which together comprise the operation of function 44. Following start 101 and initialization 102, function 44 calls a subroutine 103 to derive a non-biased address of the system call table. Upon return, the system call table is checked via subroutine 104, after which function 44 ends at 105. Subroutine 103 (FIG. 10B) pattern matching for a CALL address following an interrupt 0x80 request. This is necessary to ensure that the addresses retrieved from the system call table are authentic, and are not based on a mirror image of the system call table maliciously created by an intruder. Subroutine 103 was derived from a public source function included in the SuckIT rootkit. Following initialization 106, the subroutine loops at 107 through the first 50 bytes following the interrupt 80 to find a CALL address to a double word pointer. Once found at 108, subroutine 103 returns at 109.

Once this address has been acquired, the function uses generalized positive anomaly detection based on premise 1 which is reproduced below:

Premise 1: All Kernel Calls Should Only Reference Addresses Located within Normal Kernel Memory.

Specifically, on Linux, the starting address of the kernel itself is always located at 0xC0100000. The ending space can be easily determined by the variable _end and the contiguous range in between is the kernel itself. Although the starting address is always the same, the ending address changes for each kernel installation and compilation. On some distributions of Linux this variable is global and can be retrieved by simply creating an external reference to it, but on others it is not exported and must be retrieved by calculating offset based on the global variable _strtok or by pattern matching for other functions that utilize the address of the variable. Once the address range for the kernel is known, subroutine 104, following initialization 110, searches the entire size of the syscall table at 111. With respect to each entry, a determination 112 is made as to whether it points to an address outside the known range. If so, results are written to the output file at 113 whereby the name of the flagged system call may be displayed, along with the address that it has been redirected to. Optional calls can then be made to the forensics and restoration modules through interfaces 18. A high and low recordation is maintained and updated for each out of range system call address encountered at 114. Thus, following complete analysis of the table and based on the final highest and lowest address values, the system has determined an estimated memory range of the module responsible for patching the system call table. This range is identified as a malicious kernel rootkit.

Thus, if addresses within the system call table have been patched at 116, another subroutine 115 (FIG. 10d) is called to search the memory within the highest and lowest addresses for patched system calls. Because the highest and lowest addresses refer to a range of memory that contains the functions of the hidden module, it is utilized as a second method of module detection. Following its initialization at 118, subroutine 115 begins to loop at 119 through each module in the list. A calculation is made at 120 to determine the free space between the encountered module and the next module in the list. If the suspect region between the highest and lowest value determined by subroutine 104 (FIG. 10c) falls within this free space, results are preferably output at 122. Rather than only outputting the range of memory between the highest and lowest value, the entire range within the two modules is outputted. For example, if the highest address is 17 and the lowest address is 12, but Module A stops at 10 and Module B starts at 20 then the range 10-20 is reported to encompass all possible memory related to the functionality. Again, appropriate functions from the forensics and restoration modules can then be called via interfaces 18 to collect this data and restore that aspect of the operating system. Once subroutine 115 returns at 123, or if the lowest has not been set at 116 (FIG. 10c), then subroutine 117 also then returns.

FIG. 11 illustrates, for representative purposes, an example when the function 44 for searching hidden system call table patches is executed against a kernel which has been exploited by the Adore v0.42 rootkit. This figure identifies system calls that have been identified as patched (i.e., “FAILED”) as well as the address that the calls have been assigned to. As described above, a variable is used to store the highest and the lowest values of these addresses 125 and 127, respectively. These values correlate a range of memory pointed to by the patched system calls and is used as a second technique for hidden module detection.

The above function 44 will, thus, identify any rootkit that dynamically patches into the system call table of a running kernel. Because this model is based on a fundamental law (premise 1), no false positives will occur. Any unknown change of system call table addresses into non-normal kernel memory, thus, indicates a kernel rootkit. This model, however, does err on the conservative side and will not detect changes in addresses that are physically located within the kernel memory itself. To accomplish this, a rootkit designer would need to insert functions directly over existing kernel functions that are used only on startup or are used infrequently. This is perhaps more theoretical than practical, and the inventors are unaware that if has ever been implemented in a publicly released rootkit. Notwithstanding, the solution to detecting such an occurrence using a conservative approach is again similar to that of the biological immune system; additional sensors can be introduced for redundancy. For instance, based on the same premise 1, the model could be expanded to cover general functional integrity verification as well. For example, beginning with the system call table integrity verification model discussed above, one could check for addresses within the system call table that fall outside of the “boot” range. If all addresses are found to be within the valid range, another function could be called to trace the pointers to the level whereby the verification process is repeated. Eventually, the execution paths will be exhausted and either all functions will be located within the appropriate address range, or an anomaly will be encountered. In addition to this capability, page tables could also be analyzed to identify anomalous behavior that violates the notion that the kernel should not be calling outside areas of memory.

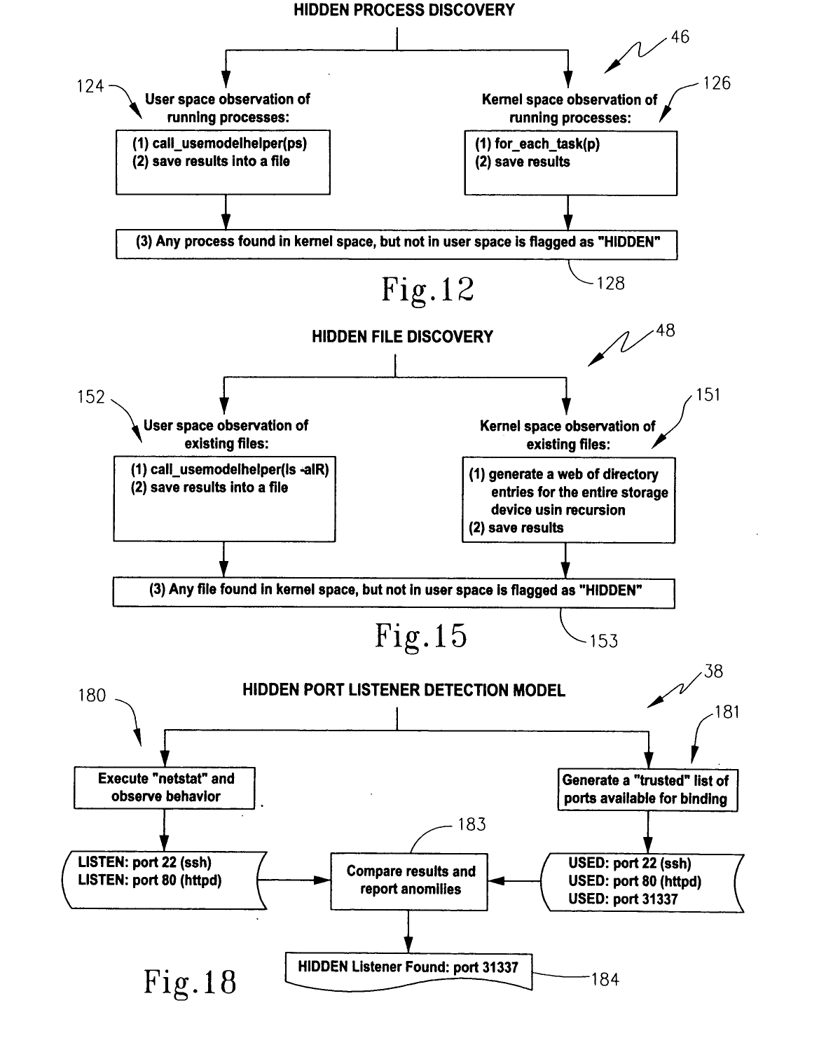

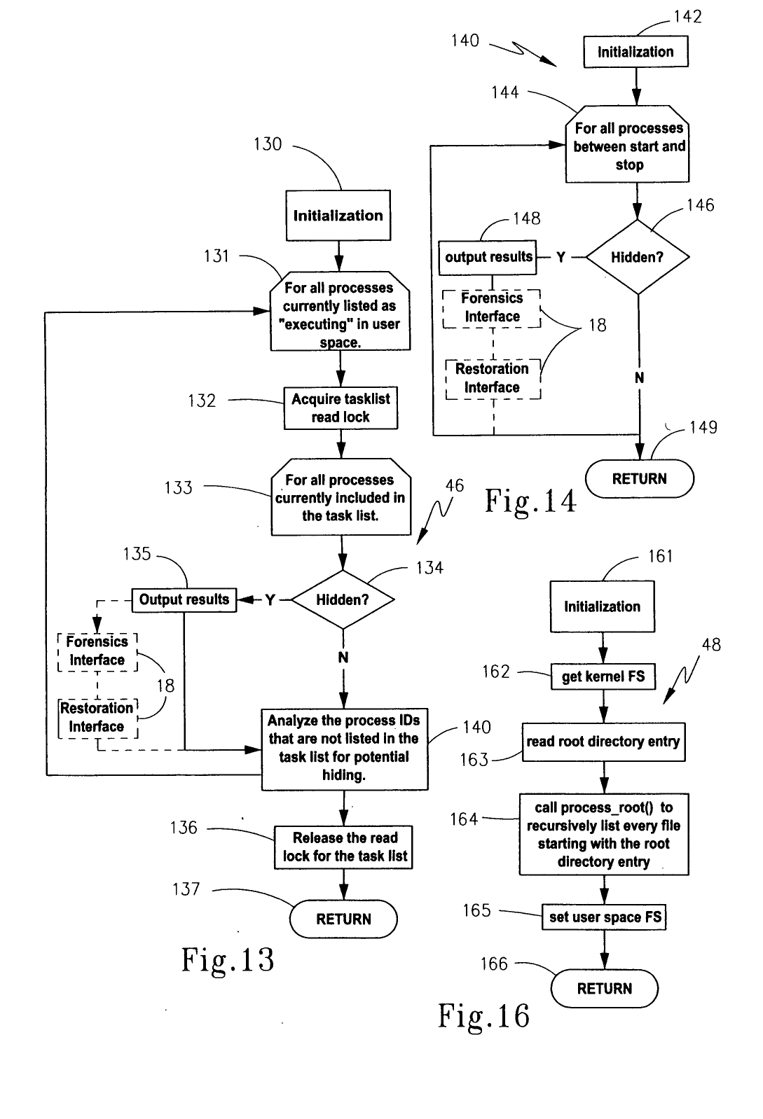

The hidden process detection function 46 (FIG. 4) is capable of identifying running processes that are hidden by either user space or kernel space rootkits. This is diagrammatically depicted in FIG. 12, and an exemplary algorithmic flow for the function is illustrated in FIG. 13. The hidden process detection model employs two different sensors. The first sensor is based on premise 3 from above that “A process visible in kernel space should be visible in user space.” This sensor executes a ps command to observe an untrusted user space view 120 (FIG. 12) of the running processes. Following this, it manually walks each element in the task structure to generate a trusted list 122 of running processes from the kernel's view. The two views are then compared at 124 and anomalies are identified which indicate that a process is hidden.

This sensor can discover process hiding techniques that rely on the notion of “PID 0 hiding” which was introduced by Adore on Linux. It can also detect hiding done by system calls, and hiding done by user space rootkits or Trojans. By default, processes with a PID of zero are not displayed by any of the systems administration utilities; therefore, simply renumbering the PID can be used to easily hide a process. The downside is that the standard exit( ) function does not operate properly with a PID of zero, so the attacker must trap all exits made by the hidden process and replace the PID to a valid number prior to exiting.

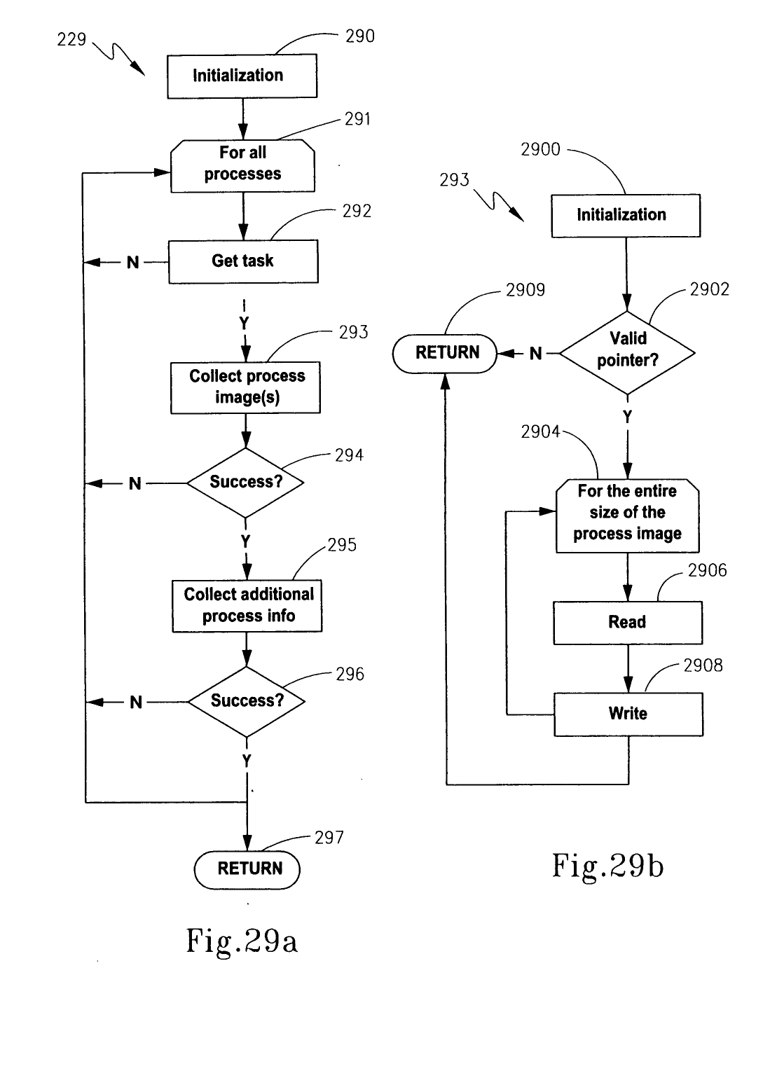

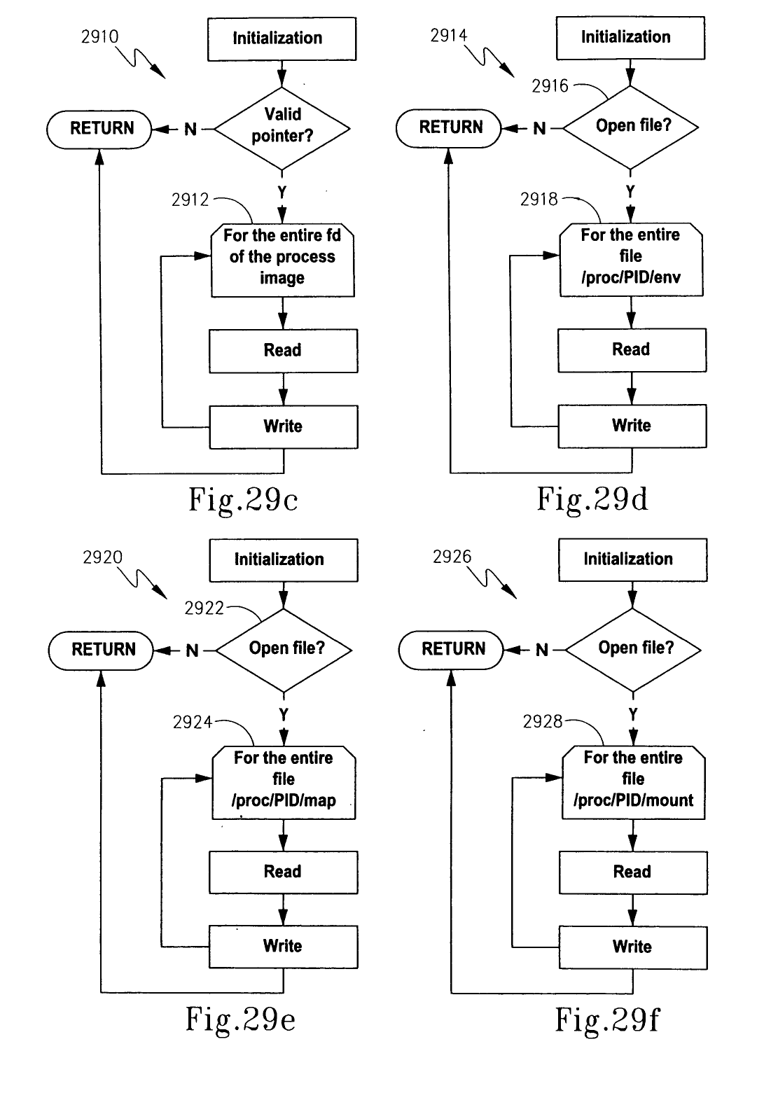

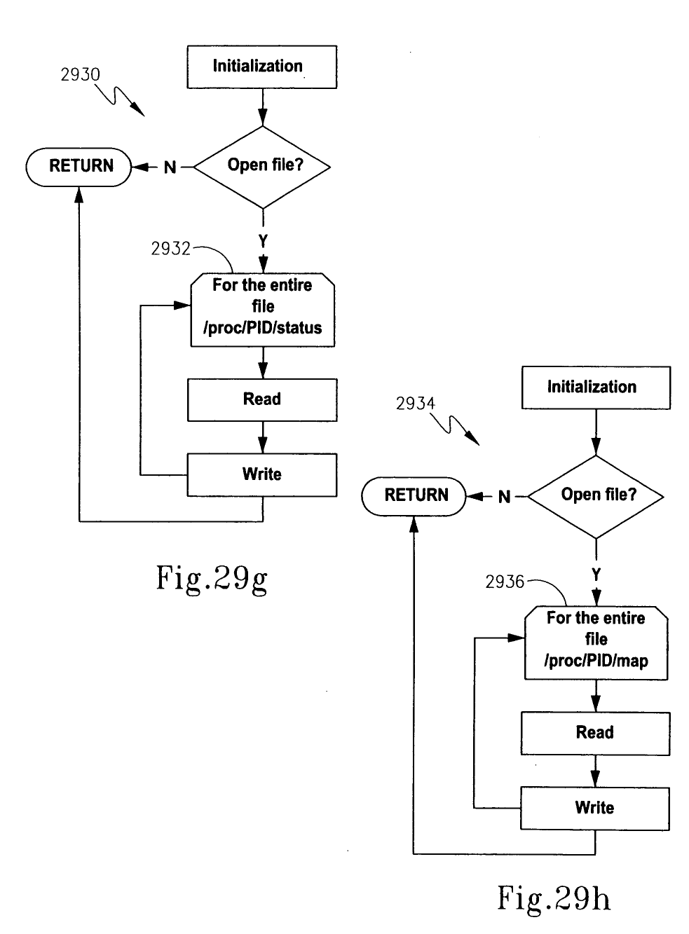

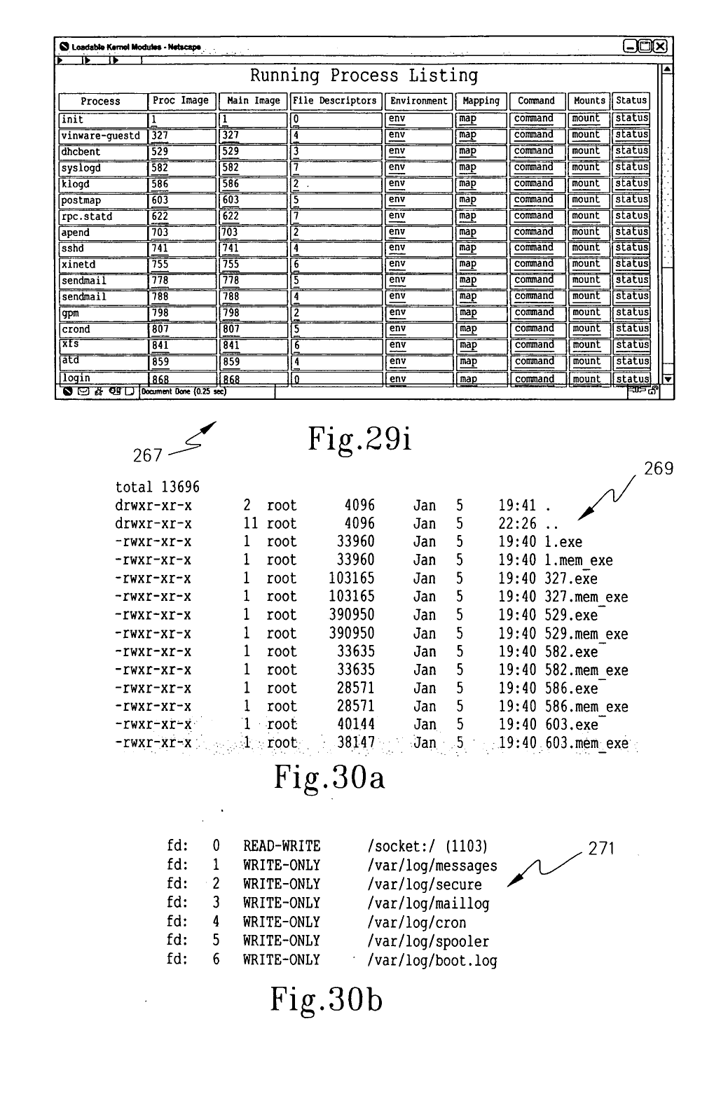

With reference to FIG. 13, the hidden process detection function 46 initializes at 130 to prepare necessary data structures, output file reports, and any user space listing of processes that are currently executing. It then performs a loop at 131 while reading in a buffer which contains a listing of all processes currently executing in user space. The read lock for the task list is acquired at 132. Another loop is initiated at 133 to analyze each element within the task list, wherein each element represents a process scheduled for execution. If the process is in the task list, but not in the user space buffer then it is deemed hidden at 134 and reported as such at 135. At this point, another procedure can be called to look for more sophisticated process hiding techniques. This subroutine 140 (described below) will detect processes that have been completely removed from the task list. When subroutine 140 completes, the loop returns to process any other elements in the buffer. Optionally, prior to executing subroutine 140, an appropriate data collection function (namely subroutine 229 in FIG. 29(a)), associated with the external forensics module 14 and/or recovery function (namely subroutine 351 in FIG. 34) associated with OS restoration module 16 can again be implemented, as represented by the phantom boxes 18 in FIG. 13. In any event, following execution of subroutine 140, the read lock for the task list is released at 137 and control is returned to the calling kernel module 34.

Although the hidden process detection model does not produce any false positives, current implementation theoretically suffers from a potential race condition that may result in innocent processes being reported. For instance, if a process exits or is created during the instance between the user and kernel space observations then an incorrect anomaly may be reported for that process. This can be corrected with additional time accounting and/or temporary task queue locking to ensure that only process changes started or stopped before a particular instance are observed. As with other detection models associated with the exploitation detection component of the invention, this model errors on the conservative side and relies on redundancy. For instance, this particular sensor is capable of detecting most hiding techniques, but it relies on the presence of the process within the kernel task queue. Although not tremendously stable, it has been demonstrated through implementation in Adore that a process can be run without being present in the task queue once it has been scheduled. To detect this hiding technique, a second negative sensor is deployed to investigate the presence of anomalies within process IDs that are not present within the task queue.

Subroutine 140 associated with the hidden process detection function 46 is diagrammed FIG. 14. This sensor is based on the premise 2 from above that “Memory pages in use indicate the presence of functionality or data.” Process file system entries are specifically searched one by one to identify the presence of a process in memory within the gap. This detects all process hiding techniques that operate by removing the process from the task queue for scheduling. Following initialization 142, where necessary data structures and report output files are prepared, procedure 140 begins to loop at 144 through each address between “start” and “stop”. Start and stop in this case get passed in by the calling procedure 46 (FIG. 13) and refers to the process IDs that are missing from the last two numbers found within the task list. For example, if the IDs 100 and 123 are linked to each other then “start” is 101 and “stop” is 122. By looking for the presence of /proc/PID/cmdline for each process ID that falls in this gap range, processes can be identified at 146 that have been hidden by being removed from the task list. If the cmdline file exists, then this is a valid process that has been hidden and information about it can be output into a results file at 148. Optional forensics and restoration functions can be called at this point via interfaces 18. On the other hand, if the cmdline file is not present at 146, then it is not a valid process and the loop is either continues at 144 to the next PID or control is returned at 149 to hidden process detection function 46 in FIG. 13.

Subroutine 140 might also suffer from the same potential race condition as the function 46 discussed above, since a process that is created or has existed between the observation of the task queue and the observation of the /proc file system could theoretically report a false anomaly. Note that like the earlier sensor, this false positive is due to an implementation based race condition and not an error in the premises or overall model. Accordingly, this implementation can also be enhanced by incorporating timing mechanisms and task queue locks to prevent the occurrence of such race conditions.

It is the intent of the inventors in the future to develop additional sensors to strengthen exploitation detection component by incorporating further redundancy. For instance, premise 2 can also be used as a basis for creating a sensor which generically searches through all kernel page tables for ELF (Executable and Linking Format) headers. These headers can be compared against those of visible processes, with any discrepancies indicating a hidden process. Regardless of the particular hiding technique employed, the rootkit cannot escape the fundamental law that the process must be located in memory to operate.

The terminal function associated with kernel module 34 (FIG. 3) is the hidden file detection function 48. This is described in the functional block diagram of FIG. 15 and the flow diagram of FIG. 16. Hidden files are perhaps the most difficult aspect of a rootkit to successfully detect. Implementation is difficult because there are potentially hundreds of different hiding techniques, file systems do not always “remove” data from the media when a file is deleted, and the increasing storage sizes of media make for a tremendously time consuming search. However, as with the other detection schemes described herein, the strength in the model depends on redundancy. The hidden file detection model is based on premise 5 from above that “Persistent files must be present on the file system media” because no hiding technique can maintain persistent files without storing them somewhere on media. Some techniques employ memory buffers that flush data out to disk only when a reboot is sensed. Since not all systems are cleanly shutdown, this does not represent true persistence. An unexpected power failure will shut the computer down without flushing the hidden file to disk. However, for completeness, it is intended that future implementations of the model will incorporate a sensor based on the second premise that “memory pages indicate the presence of functionality or data” to detect files located only in memory.

The hidden file detection function 48 operates by first observing a kernel space view 151 of visible files which are deemed “trusted” (FIG. 15). Each listing is then searched for in user space 152 to determine if there is a correspondence between them. Based on the results obtain, a determination 153 can be made whether the file is hidden or not. The kernel portion of the implementation can be appreciated with reference to FIG. 16. As with other routines, upon initialization 161, hidden file detection function 48 prepares necessary data structures and report output files. At 162, the original file system setting is saved and the current settings are changed to kernel space. The root directory entry is then opened and read at 163. The subroutine process_root( ), which is based on an open source function within the Linux kernel, is then called at 164 to generate a complete recursive listing of all files and directories that fall within the root directory. The results are printed to the file descriptor discussed above with reference to the kernel module's initialization 41. In addition to the filename, the inode and file size are also printed. At 165, the file system is then set back to the original user setting that was saved at 162, and control returns at 166.

As with hidden process detection, the current implementation of the hidden file detection model could potentially suffer from race conditions that result in false positives if files are removed during the instance between user space and kernel space analysis. This is a limitation in implementation and not the model itself, and can be solved by incorporating timing and/or temporary file system locking mechanisms. For speed, the current model conducts searches based in cached entries. In the future, more robust searching techniques could be devised and implemented. In addition, enhanced negative detection sensors could be created and deployed to specifically search in areas that are known to store other malicious data, such as the previously detected hidden process, kernel module, or files currently opened by them.

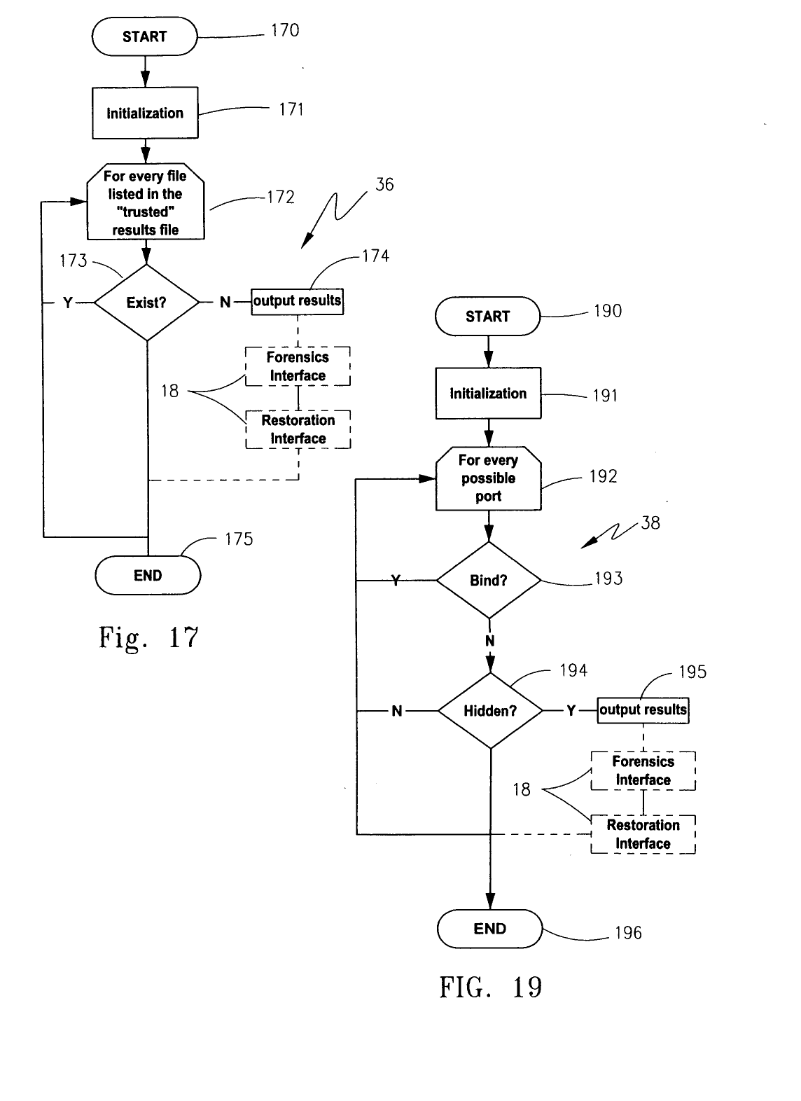

Returning now to the exploitation detection component diagram of FIG. 3, it is recalled that the file checker script 36 is executed upon completion of kernel module 34. FIG. 17 shows the program flow for this script. Upon starting at 170, the necessary variables are initialized at 171 and the “trusted” file listing generated by kernel module 34 (FIGS. 15 & 16) is opened for reading. A loop is initiated at 172 to analyze each file in the “trusted” file listing. If the file exists at 173 (i.e. if it is visible) in user space from this script, then the loop returns to analyze the next file in the listing. If the file is not visible then it is reported as hidden and the name is stored in the results file at 174. Here again, the forensics and restoration modules can optionally be called at this point, via interfaces 18, to collect pertinent data and perform pertinent OS repair. Once the recursive looping 172 is completed, the script ends at 175.

The port checker script 38 (FIG. 3) is then initiated. This script is outlined in FIGS. 18 & 19. Port checker script 38 is similar to the hidden process detection function discussed above because it operates by observing both a trusted and untrusted view of operating system behavior. This model is based on premise 4 from above that “All unused ports can be bound to.” With initial reference to FIG. 18, the untrusted view 180 is generated by executing netstat, and the trusted view 181 is accomplished by executing a simple function that attempts to “bind” to each port available on the computer. These views are compared 183 to identify at 184 any hidden listeners. FIG. 19 illustrates the routine for implementing this functionality. Once launched at 190, it too initializes at 191 to establish necessary variables and generate an “untrusted” user space view utilizing netstat results. A loop is then started at 192 for every possible port on the computer system (approximately 35,000). If the port checker is able to bind to the encountered port at 193, this means that there is no listener installed, so the script progresses to the next port in the loop at 192. If the encountered port cannot be bound to, then a determination is made as to whether the port is listed in the “untrusted” netstat listing. If the port is listed in the “untrusted” user space listing of ports according to netstat, then at 194 it is deemed not hidden so we progress to the next port in the loop. If the encountered port is not listed, this corresponds to it being hidden so its name is saved in the results file at 195. Appropriate forensics and restoration functions can be called at this point via interfaces 18, as with earlier procedures. In particular, the process collection function of FIG. 29(a) below could be called to interface with the forensics module and the process termination function of FIG. 34 below could be called to interface with the recovery module. Once all ports have been tested, port checker script 38 terminates at 196.

It is believed that, in order for a port listener to defeat this function, it must erroneously redirect all bind attempts to the hidden port. The redirection would either have to return a false “positive” that the bind attempt was successful, or would have to redirect the bind to a different port. Both behaviors noticeably alter the behavior of the operating system and are ineffective methods of hiding. For instance, if this system were expanded to actually conduct a small client server authentication test in addition to the bind, then it would discover that the listener present on the port does not match the anticipated “self” behavior. Nonetheless, it is envisioned that future implementations could incorporate such tests for just that purpose. Additional sensors could also be created to collect raw TCP/IP traffic behavior from within the kernel itself to further expand detection to non port bound listeners.

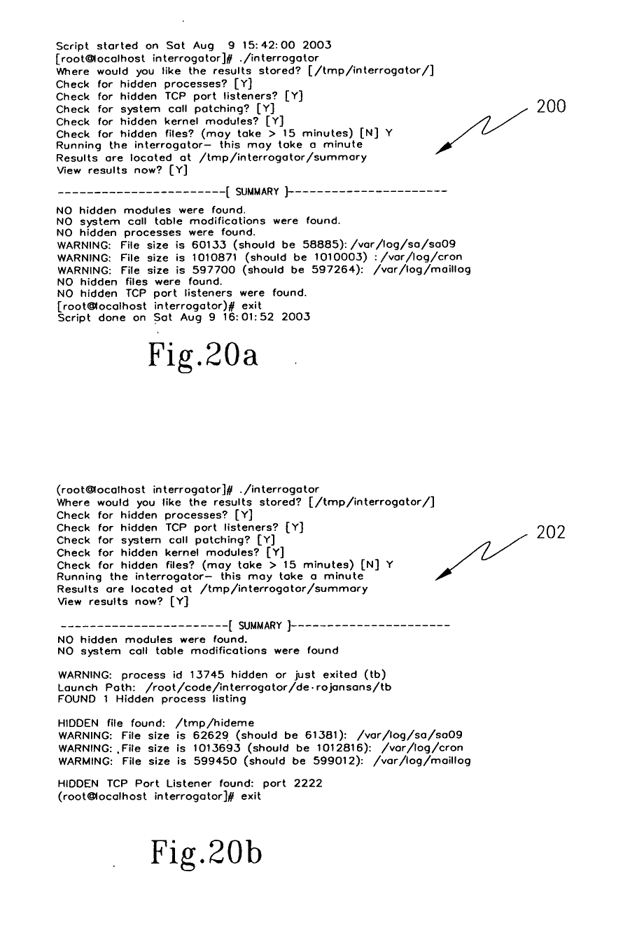

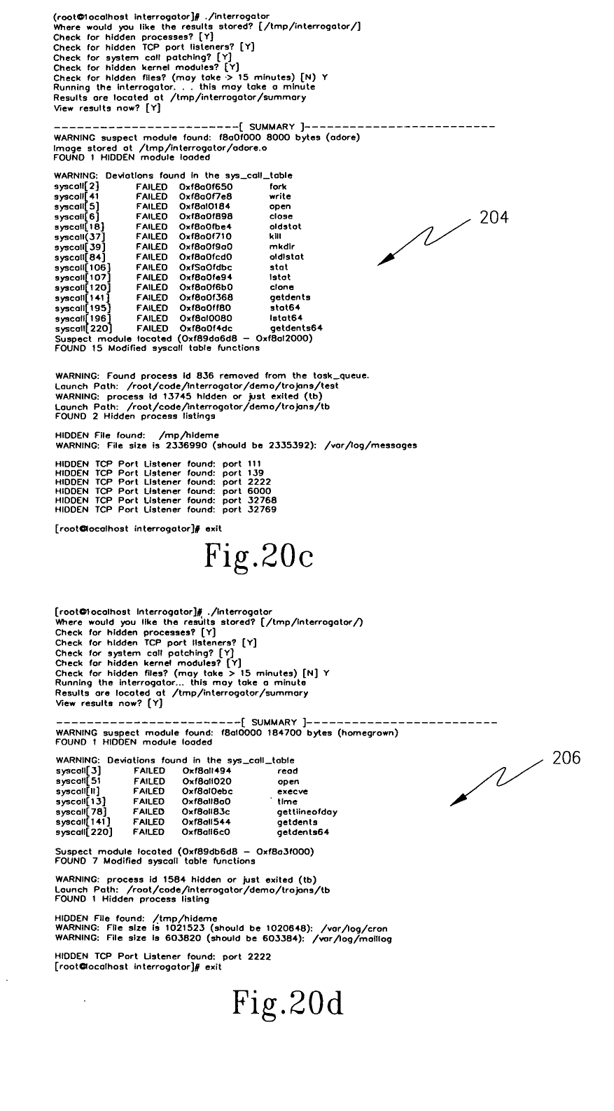

Having described in detail in FIGS. 3-19 the exploitation detection component 12 for the software security system 10 of the invention, reference is now made to FIGS. 20(a)-(d) to illustrate representative test results obtained with the detection component. The results shown demonstrate that this component is tremendously effective at detecting operating system compromises involving rootkits and backdoors. Tests were conducted on a computer with a standard installation of the Linux 2.4.18-14 operating system. The actual execution of the exploitation detection component (not including hidden file detection 48) can take less then one minute to complete. However, when hidden file searching is incorporated, the execution time can dramatically increase (approximately 15 minutes for a 60 GB hard drive). Two types of tests were initially conducted: (1) executing with and (2) executing without searching for hidden files., However, results from hidden process detection 46, port checker 38, system call patching 44, and hidden module detection 42 were identical in both types of tests so subsequent tests only involved searching for hidden files.

FIG. 20(a) shows results 200 reported when the system was executed against a clean system. In this case no hidden modules, system calls, processes, files, or port listeners were reported. The only reported anomaly is listed at 202 only as a “WARNING” that file sizes increased for three of the system logs during the execution.

FIG. 20(b) shows results 202 that were reported when the exploitation detection component 12 was executed against a system with user space Trojans of ps, ls, and netstat. As can be seen in this figure, the user space Trojans were designed to hide the process ID 13745, the file /tmp/hideme, and a TCP port listener located on port 2222. As can be seen, all were successfully detected.

Two different kernel space rootkits were also tested, with results shown in FIGS. 20(c)&(d), respectively. The first was Adore version 0.42. This is one of the most popular and advanced rootkits publicly available. In addition to standard system call based process hiding it also includes the capability to remove process from the task queue as discussed earlier. Results 204 obtained when the exploitation detection component was tested against Adore are shown in FIG. 20(c). In this case, it may be seen that Adore was configured to hide process ID 13745 using standard system call hiding techniques and to physically remove process ID 836 from the task queue. Both were easily detected by the exploitation detection component. In addition, even though the module was physically removed from the module listing it is quickly identified. All 15 system calls Adore patched were discovered. The file /tmp/hideme that was hidden was discovered, and the only other disk warning was that /var/log/messages increased slightly in size. The port hidden by Adore was 2222, which was discovered. However, because the implementation of Adore physically breaks netstat's ability to output to a pipe, there is no “untrusted” view to compare against. Therefore all bound ports are reported whether malicious or not.

The second kernel rootkit test was conducted against a homegrown rootkit that does not match the signature of anything currently known. Therefore, as explained in the Background section, such a rootkit cannot be detected by Chkrootkit or others that are signature based. The results 206 of the exploitation detection component on the homegrown rootkit are illustrated in FIG. 20(d). As with the previous kernel level rootkit test, the module itself is discovered. All seven of the patched system calls were discovered. The process hiding technique is based on system call patching, and the hidden process ID 1584 was detected as in the other examples. The hidden file /tmp/hideme was detected and two warnings were issued because of sizes increases in log messages. The hidden TCP listener on port 2222 was also detected. Because this rootkit does not physically break netstat like Adore, no additional false positive port listeners were listed.

Due to the demonstrated success of this exploit detection model it is contemplated, as discussed above, that the current system can be expanded to include additional sensors based on the previously discussed five premises/laws. One particular enhancement could be the implementation of a redundancy decision table that is based on the same derived premises and immunology model discussed herein. That is, rather than relying on a single sensor model for each area of concern, hybrid sensors could be deployed for each level of action related to the focal area. The following chain of events are exemplary of what might occur to detect a hidden process:
1. A user space “ls” is performed
2. The getdents system call is made
   The results of actions 1 and 2 are compared, and any anomalies between the two indicate that the “Is” binary has been physically trojaned by a user space rootkit.
3. The sys_getdents( ) function is called from the kernel
   Any anomalies between 2 and 3 indicate that the system call table has been patched over by a kernel rootkit. The kernel will then be searched for other occurrences of addresses associated with the patched function to determine the extent of infection caused by the rootkit.
4. The vfs_readdir( ) function is called from the kernel
   Any anomalies between 3 and 4 indicate that the function sys_getdents( ) has been physically patched over using complex machine code patching using a kernel rootkit. Although this patching technique has not known to have been publicly implemented, it is theoretically possible and therefore requires defensive detection measures.

5. Raw kernel file system reads are made

Any anomalies between 4 and 5 indicate that vfs_readdir( ) or a lower level function has been patched over by a complex kernel rootkit.

6. Raw device reads are made

Any differences between 5 and 6 indicate that a complex hiding scheme that does not rely on the file system drivers of the executing operating system has been implemented. The same series of decision trees can be built for the flow of execution of all system calls.

### B. Forensics Data Collection Component

Import to an investigation is accessibility to all available evidence. The problem with traditional digital forensics is that the range of evidence is restricted by the lack of available methods. Most traditional methods focus on non-volatile memory such as computer hard drives. While this was suitable for older compromise techniques, it does not sufficiently capture evidence from today's sophisticated intruders.

The forensics data collection component 14 of security product/system 10 is capable of recovering and safely storing digital evidence from volatile memory without damaging data present on the hard drive. Acquisition of volatile memory is a difficult problem because it must be transferred onto non-volatile memory prior to disrupting power to the computer. If this data is transferred onto the hard drive of the compromised computer it could potentially destroy critical evidence. In order to ensure that hard drive evidence is not corrupted this system, if desired, immediately 1) places all running processes in a “frozen” state, 2) remounts the hard drive in a read-only mode, and 3) stores all recovered evidence on large capacity removable media. For illustrative purposes, the media might be a 256M USB 2.0 flash drive, but could be any external device with adequate storage. In general, 1M is required for each active process. The forensics component is also capable of collecting and storing a copy of the system call table, kernel modules, the running kernel, kernel memory, and running executables along with related process information. Use of this system will enhance investigations by allowing the inclusion of hidden processes, kernel modules, and kernel modifications that may have otherwise been neglected. Following collection, the component can halt the CPU so that the hard drive remains pristine and ready to be analyzed by traditional methods. As with the exploitation detection component above, this approach can be applied to any operating system and has been proven through implementation on Linux 2.4.18.

By putting the processes in a frozen “zombie” state they can not longer be scheduled for execution, and thus any “bug out” mechanisms implemented by the intruder cannot be performed. In addition, this maintains the integrity of the process memory by not allowing it to be distorted by the behavior of the forensics module. Placing the hard drive in a read-only mode is important to protect it from losing integrity by destroying or modifying data during the forensics process. Likewise, all evidence that is collected is stored on large capacity removable media instead of on the hard drive of the compromised computer. These three requirements ensure that data stored on the hard drive remains uncontaminated just as it would if the power were turned off while evidence is safely collected from volatile memory.

The forensics data collection component addresses each of the important aspects of computer forensics discussed above in the Background section, namely, collection, preservation, analysis and presentation. On the one hand, it presents a technique for collecting forensics evidence, more generally forensics data, that is characteristic of an exploitation. The component preferably collects the data from volatile memory. It then stores the data on removable media to ensure the preservation of the scene as a whole. The results are efficiently organized to aid in the analysis process, and all of this is accomplished with an eye toward satisfying the guidelines established in Daubert so that acquired evidence can be presented in legal proceedings.

The forensics data component 14 is introduced in FIG. 21. As with the exploitation detection component, it can also incorporate a prototype user interface 212, referred to as “forensics” for distinction, which is also a “shell” script programmed in “/bin/sh”. Interface 212 is responsible for starting the associated kernel module (main.c) 214. Forensics kernel module 214 is loaded, executed and then unloaded and, as with the exploitation detector's kernel module, is the primary component of the forensics system 14. The forensics component ends 216 once its associated kernel module 214 completes execution.

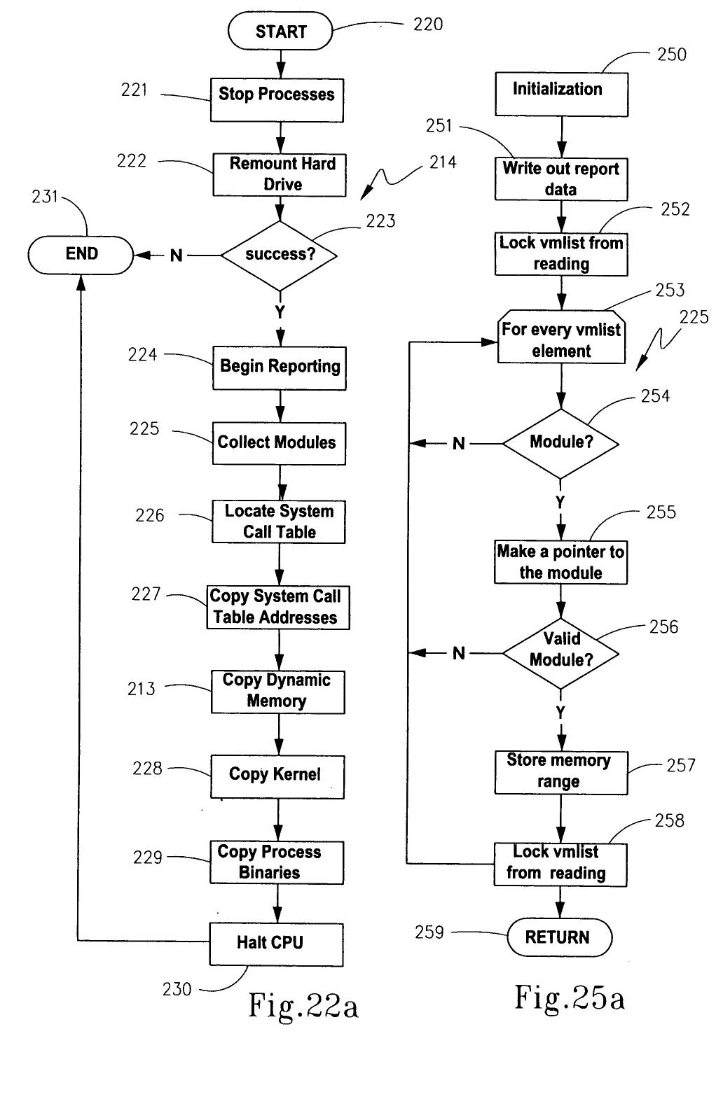

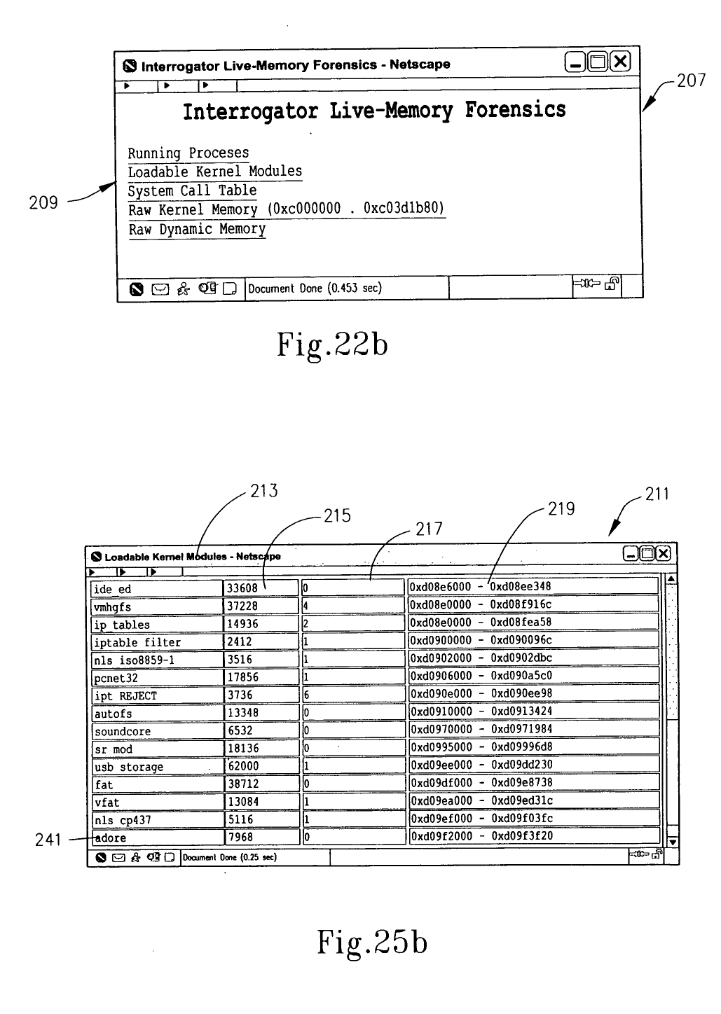

A high-level program flowchart illustrating the principle features for forensics kernel module 214 is shown in FIG. 22(a). Although not depicted, it is to be understood that module 214 incorporates the same initialization considerations discussed above for the exploitation kernel module, so that a discussion of them need not be repeated. Once started to 200, a function 221 is called to prevent execution of all processes on the computer. The processes are placed in a “frozen” state so that no new processes can be initialized. This prevents the execution of potential “bug out” mechanisms in malicious programs. Thereafter, at 222, the hard drive is remounted using the “READ-ONLY” flag to prevent write attempts that could possibly modify evidence data on the hard drive. If the remounting of the hard drive is deemed unsuccessful at 223, the system exists whereby and the program flow for forensics kernel module 214 ends at 232.

If, however, hard drive remounting is successful the program continues at 224 to call a function to create initial HTML pages in preparation of displaying program results. All kernel modules, whether visible or hidden from view, are collected from memory at 225 and stored onto removable media. Because the address of the system called table is not publicly “exported” in all operating system kernels, it is preferably determined after 226, and corresponds to subroutine 103 in FIG. 10(b) above. This function is based on a publicly available technique, namely that utilized in the rootkit “SuckIT” for pattern matching against the machine code for a “LONG JUMP” in a particular area of memory, wherein the address of the JUMP reveals the system call table; however, other non-public techniques to do this could be developed if desired. At 227, the value/address of each system call is stored on removable media. The range of dynamic memories is then stored on removable media at 213. A copy of the kernel in memory on the computer system is then stored onto removable media at 228. At 229, a copy of the process binary from the hard drive and a copy of the stored image from memory are stored on removable media. This will collect both the binary that was executed by the intruder and a decrypted version if encryption is used. Once the entire system has completed, the processor is “halted” at 230 and the computer automatically turns itself off. Thereafter, the program flow for forensics kernel module 214 ends at 231. Other than the requirement that the process halting and hard drive remounting (if they are desired) must take place prior to the forensics collection functionality, the remaining forensics data collection functions of FIG. 22(a) may be reordered if desired.

FIG. 22(b) shows a main report page 207 which can be generated by the forensics data collection component. As the description continues below to explain the various functions associated with the forensics kernel module 214 of FIG. 22(a), at times reference will made to the various links 209 within the main report page 207 from which additional output report pages can be displayed. All results are preferably stored on large capacity external media. The HTML web pages are automatically generated when the system is run to aid in the navigation of recovered data.

With that in mind, various ones of the embedded functions called within the forensics kernel module 214 will now be described in greater detail with reference to FIGS. 23-30(g). Turning first to FIG. 23, the function 221 for preventing execution of all process is described. Since remounting of the hard drive could theoretically trigger this event, all processes are first placed in a frozen state. This is accomplished by changing the state flag in their task structure to TASK_ZOMBIE. More particularly, when function 221 is called, the kernel write locks must be acquired prior to modifying in the task list. Accordingly, the task list is locked for writing at 233. A loop is initiated at 234 for each process that is scheduled for execution. The current implementation uses the built-in Linux kernel for_each_task function, but it can be made more generic for easier portability across other operating system platforms. Processes must be excluded in order to retain a skeleton functionality of the operating system. More specifically, processes are excluded which are necessary for writing the collected data out to the USB drive or other removable media. Presently, this is a manual process and the user is asked to enter the process ID of the excluded process; of course, this can be easily automated if desired. In any event, if a process is excluded at 235 the loop returns to 234 to address the next process that is scheduled for execution.

If not excluded at 235, the process is frozen at 236 from being scheduled further by changing its state to “ZOMBIE”. The ZOMBIE flag refers to a process that has been halted, but must still have its task structure in the process table. In essence, then, all of its structures and memory will be preserved but it is no longer capable of executing. This modification is related to an accounting structure used only by the scheduling algorithm of the operating system and has no effect on the actual functionality of the process. Therefore, any data collected about the process is the same as if it were still executing; this action simply prevents future scheduling of the process. With the exception of the daemon used to flush data out to the USB drive and the processes associated with the forensics kernel module, all other processes are frozen immediately upon loading of the module. The only real way a process could continue to execute after being marked as a zombie would be if the scheduler of the operating system was completely replaced by the attacker. In any event, after the pertinent processes are frozen, the kernel write locks are released at 237 and control is returned at 238.

Although the freezing of processes technically prevents most write attempts to the hard drive because there are no programs running, this system applies an additional level of protection by forcing the root partition of the file system to be mounted in “read only” mode. Remounting the file system in this mode prevents all access to the hard drive from both the kernel and all running processes. This approach could potentially cause loss of data for any open files, but the same data would have been lost anyway if the computer was turned off using traditional means. The algorithm 222 used to protect the hard drive is demonstrated in FIG. 24. Upon initialization 240, an attempt is made to create a pointer to the root file system super block. An inquiry is then made at 242 to determine if the pointer is valid and if the file system supports remounting. If not, function 222 returns at 246. If, however, the response at 242 is in the affirmative, the file system is remounted RD_ONLY (read only). Doing this prevents future write attempts to the hard drive. It should be noted that operating systems can have multiple file systems mounted at any given time. As a prototype implementation at this point, the present system only remounts the “root” or primary file system, but as an expansion it could remount all if necessary. The implementation difference of this is minimal, since it's merely entails multiple remounts. Accordingly, the remounting technique described herein could readily be expanded to remount all partitions as well as implement other halting practices for redundancy, as required.

Next the module begins to prepare the output reporting in subroutine 224 by opening output file pointers and initializing the HTML tables used to graphically display the results. The module(s) collection function 225 is now described with reference to FIG. 25(a). As discussed above, loadable kernel modules are popular implementation methods used by kernel rootkits. Because of this, the forensics data collection component is designed to collect all modules currently loaded into memory. Detection of the modules is based on the approach discussed above with reference to exploitation detection component 12 (FIG. 8), and does not rely on modules viewable through standard means. As the section above discussed, kernel modules can be easily unlinked by intruders which prevents detection through the operating system. The technique employed in the present system instead searches through dynamic kernel memory for anomalies that have the compelling characteristics of kernel modules. With brief reference again to FIG. 7 discussed earlier, the range of memory associated with kernel modules is retrieved and stored on the removable media. Each image collected contains all functionality of the kernel module, but is not able to be directly loaded into memory because it is missing the ELF header. This header is merely required for dynamically loading programs and modules into memory by the operating system and has no effect on the behavior of the module itself. The retrieved image contains all of the data necessary to determine the functionality of the recovered module. In an effort to maintain the original integrity of the image retrieved, generated headers are not automatically appended to these modules. A new header can be easily affixed to the retrieved image later if necessary.

The function 225 responsible for this collection of the modules is shown in FIG. 25(a), and is similar to function 42 above for the detection component. That is, since the forensics module can be designed to operate independently of the detection module, if desired, its module collection routine 225 by default would in such case retrieve a copy of every module in memory based on the notion that it is preferred to collect everything and discard what is not needed at a later time. However, in a situation where the forensics component/module is interfaced with the exploit detection component/modules, it would likely only collect data on modules already deemed hidden by the detection component. This same logic applies to other collection aspects of the forensics component and the description of it is to be understood bearing this capability in mind.

Accordingly, upon initialization 250, the data structures and pointers utilized in its operation are created. Headers and columns for the reports are established at 251 and the read lock for the vmlist is acquired at 252. For each element in the vmlist at 253, an inquiry is made as to whether the element (page) of memory has the look and feel the kernel module at first glance. In other words, a determination is made as to whether it begins with the value sizeof(struct module). If so, a pointer is made at 255 to what appears to be a module structure at the top of the selected memory page. A verification is made at 256 to determine if important pointers of the module structure are valid. If not, the loop returns to 253 and continues to the next element, if any, of the vmlist. If the module is deemed valid, at 257 a subroutine is invoked to store the range of memory where the kernel module is located. Once each element in the vmlist has been analyzed, it is unlocked from reading at 258 and control is returned at 259.

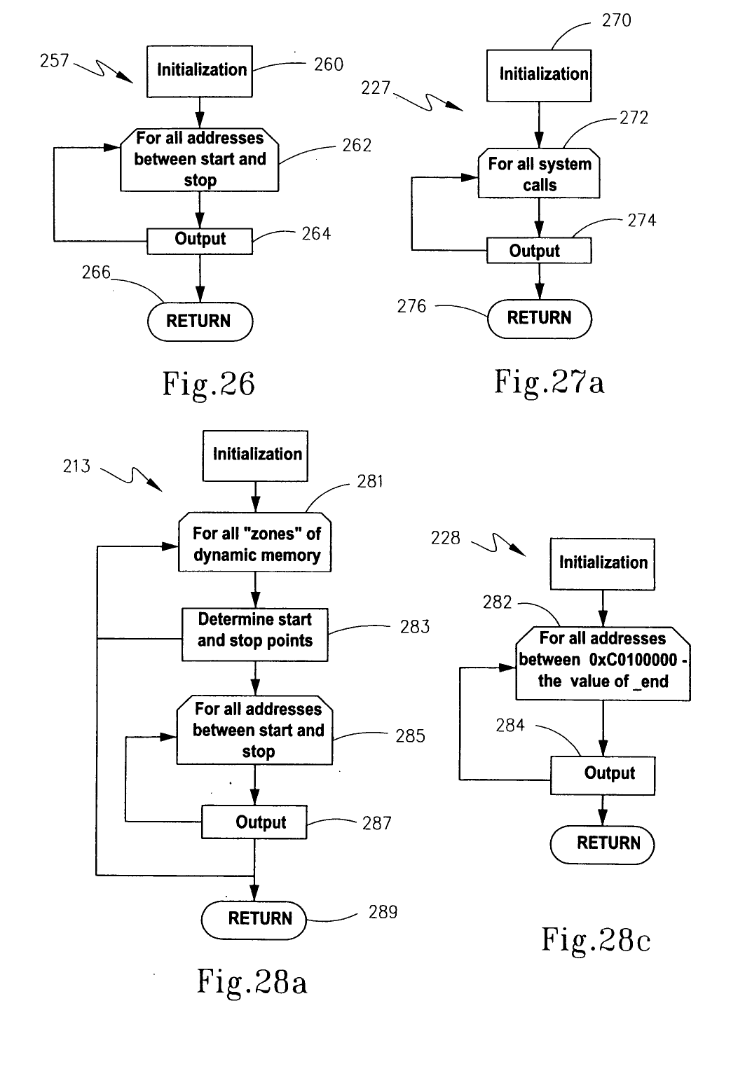

The reader should appreciate that the modules collection function 225 of FIG. 25(a) is very similar to function 42 discussed in FIG. 8 above with reference to exploitation detection component 12. In fact, subroutine 257 thereof is the same routine which is optionally accessible through the forensics interface 18 in FIG. 8 above. This embedded subroutine 257 is responsible for writing the raw module data out to disk, and is shown in FIG. 26. Following initialization at 260, whereby the necessary data structures and report output files are prepared, a loop is begun at 262 for each address between “start” and “stop”. At 264, the value of each such address is output to the removable media, and the subroutine 257 thereafter returns at 266 to calling function 225 in FIG. 25(a).

All loadable kernel modules are recovered even when intruders hide them by removing their presence in the module queue as discussed above in connection with FIG. 7 of the exploitation detection component. Representative FIG. 25(b) shows an example of results 211 generated by the forensics component when the above kernel module collection routine is executed. The results can be displayed by clicking on the appropriate link from main page 207 in FIG. 22(b). As may be seen, the table of FIG. 25(b) includes various columns 213, 215, 217 & 219 which respectively provide 1) a link to the recovered image, 2) the size of the image, 3) the number of references to the module, and 4) the memory address space that the module is located in. The highlighted entry 241 demonstrates that, even though the hacker rootkit Adore is automatically removed from the queue as a hiding technique, it is recovered by this system. Moreover, the address range listed (0xd09f2000-0xd09f3f20) can be correlated with the patched calls list generated by the system call table collection module described below.

As discussed above with reference to the exploitation detection component 12, most kernel rootkits operate by replacing function pointers in the system call table. This forensics component 14 recovers and stores these addresses so that a forensics expert can later determine if they have been modified, and if so where they have been redirected. The data of the addresses can be reviewed later to determine the exact functionality of the replacements. FIGS. 10(b) above described the procedure for obtaining the address of the system call table. That procedure is identical to the function 226 (FIG. 22a) associated with the forensics kernel module 214. Accordingly, its description need not be repeated.

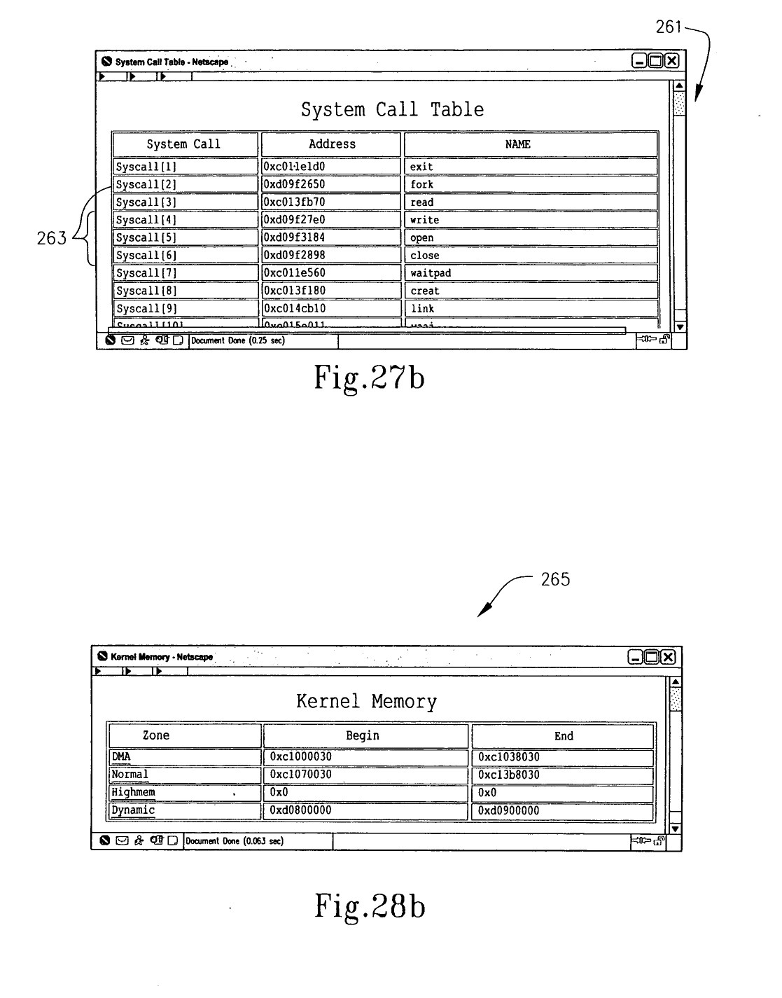

Following identification, a function corresponding to box 227 in FIG. 22(a) stores the addresses of the system call table, and a flowchart corresponding to this functionality is shown in FIG. 27(a). Since the functionality of routine 227 is similar to that discussed above in FIGS. 10(a)-10(d) for the exploit detection component, a summary need only be illustrated in FIG. 27(a) for a complete understanding. With this in mind, function 227 initializes at 270, as with others, whereby necessary data structures and report output files are prepared. A loop begins at 272 through each call in the system call table and the address of each encountered call is output at 274. Results are placed in a table on the removable media, addresses found will either fall in the 0xC0100000-_end address range which legitimately belongs to the kernel, or they will reside in the dynamic address range (0xXXXXXXX or 0XFXXXXXX depending on machine architecture). Once the output results are generated, the function returns at 276.

FIG. 27(b) shows a representative example of results 261 tabulated by the forensics component when the system call table collection routine is executed. The results can be displayed by clicking on the appropriate link from main page 207 in FIG. 22(b). As illustrated by the various columns in the table, the system generates a listing of the call number, address, and name for each entry of the system call table. This data can be visually inspected by an expert to identify anomalies (i.e., when a call points out of the memory address space for the static kernel), or analysis software can be designed to aid in the process. The benefit of recording each call address is that it can be correlated to the exact function in memory. For example, the call addresses indicated by the shadowed rows 263 appear to be malicious because they are out of the static kernel range listed on the main report page (0xC0100000-0xC03d1b80). Instead they are located in the 0xDXXXXXXX range. Further, each address can be associated with a specific function located, for instance, within the Adore module highlighted in FIG. 25(b). Therefore, this demonstrates that 1) the system call table has been patched, 2) the module responsible for patching the module is “adore”, and 3) the exact functionality of the patched function is captured and stored on removable media for additional analysis.

It is also desirable that the forensics data collection component store the kernel's dynamic memory for evidentiary purposes because addressing data recovered from the system call table collection, algorithm 227 above, can be used to cross-reference the actual replacement function in memory to determine its functionality. That is, in the event that the addresses of the system call table point elsewhere, the kernel's dynamic memory is collected to capture intruder implants that directly inject themselves into the memory of the kernel itself. The evidence found in this memory would otherwise be lost if traditional non-volatile recovery methods were conducted. In the present implementation of the forensics component, only the DMA and Normal memory are physically retrieved; however the system is designed and capable of retrieving all memory as well if desired.

Accordingly, it is desirable to collect the kernel's dynamic memory, identified as function 213 in FIG. 22(a). This function is illustrated in FIG. 28(a). The respective start and stop address values of this collection function 213 are based on information created and stored by the kernel. Specifically, the zone_table[i]->zone_start_mapnr is the start address, and this value plus zone_table[i]->size is the ending address. Thus, for each zone of memory identified at 281 by the zone_table address, the start and stop addresses are determined at 283. For all addresses between them at 285, the corresponding memory is written to the output file at 287. Thereafter, at 289, function 213 returns. Representative FIG. 28(b) shows an example of results 265 generated by the forensics component when the kernel memory collection routine is executed. Again, these results can be displayed by clicking on the appropriate link from main page 207 in FIG. 22(b).

It is very difficult to identify an intruder and collect evidence against them when the running kernel of the system is modified. The best method of recovering this evidence is to store a copy of the image itself and compare it against what is physically located on disk, or against a trusted copy. From the forth link on the main report page 207 of FIG. 22(b), a copy of the kernel taken from memory can be analyzed. For representative purposes, main report page 207 shows in the link that forensics component retrieved the kernel physically located in 0xC0100000-0xCO3d1b80.

More sophisticated intruders have developed mechanisms for directly modifying the running kernel instead of relying on loadable kernel modules or patching over the system call table. Therefore, this system also stores, at 228 in FIG. 22(a), a copy of the running kernel for analysis by a forensics expert. The algorithm for accomplishing this is illustrated in FIG. 28(c). For all system calls 282, this function 228 operates by retrieving a copy of all memory between 0xC0100000—the end variable and outputs this information at 284.

Prior to halting the entire system at 230 in FIG. 22(a), the final function called by the forensics kernel module 214 pertains to the collection of process information, identified at 229 in FIG. 22(a). One of the prime benefits to collecting evidence from volatile memory is to recover data from running processes. These processes may include backdoors, denial of service programs, and collection utilities that if deleted from disk would otherwise not be detected. Several aspects of processes are important in the evidence collection process. For each process that is running, the forensics component collects: the executable image from the proc file system, the executable from memory, file descriptors opened by the process, the environment, the mapping of shared libraries, the command line, any mount points it has created, and a status summary. The results are stored on removable media and can be easily navigated using the HTML page that is automatically generated.

A global function for 229 for acquiring this various information is shown in FIG. 29(a). After the usual initialization at 290, algorithm 229 begins at 291 to loop through every possible process ID and, for each, attempts to obtain a task structure at 292. A subroutine 293 (FIG. 29b) is then called to collect process image(s) from memory which can later be compared to the image on the hard drive or a pristine version stored elsewhere to identify signs of a compromise. If image collection is successful at 294, further processing information is collected via additional subroutines, collectively 295 (FIGS. 29c-h). Otherwise, the loop returns to the next process ID at 291. Following successful collection of the additional processing information at 296, algorithm 229 returns at 297.

The technique for retrieving the executable from the proc file system is straightforward—the file is opened and re-written to removable media. This version of the binary retrieved by subroutine 293 comes from a symbolic link to the original executable. This will provide evidence of the initial binary that is started by the intruder. However, many intruders have implemented binary protection mechanisms such as burneye to make analysis of the executable more difficult. Utilities such as this are self-decrypting which means that once they are successfully loaded into memory they can be captured in a decrypted form where they can be more easily analyzed. To take advantage of this weakness and enable the collection of further evidence this forensics component collects a copy of the image from memory as well. The subroutine 293 for collecting each process image from the proc file system is shown in FIG. 29(b). This method actually retrieves a copy of each running image from memory that can be used to reverse engineer and analyze executables that have implemented many forms of binary protection. After initializing at 2900, a verification is made at 2902 as to whether the pointer to the memory image is valid. Assuming this to be the case, a loop begins at 2904 through each address of the process binary in memory. For each such encountered address, a buffer of the binary is read from memory at 2906, and this buffer is written out to the removable media that 2908. Thereafter, at 2909 the algorithm returns.

In addition to the binary itself, much more forensics evidence can be collected about processes and the activities of intruders by recovering process information. Accordingly, other useful processes information contemplated, collectively, by subroutine box 295 in FIG. 29(a) will now be discussed. One such item of information is the collection of open file descriptors. Most programs read and write to both files and sockets (i.e., network connections) through file descriptors. For example, if a malicious program is collecting passwords from network traffic it will likely store them in a log file on the hard drive. This log file will be listed as an open file descriptor and will give a forensics expert an indication of exactly where to look on the hard drive when conducting traditional non-volatile analysis. FIG. 29(c) illustrates the flow of a function 2910 capable of retrieving this information from the process's virtual memory. This functional flow is identical to that associated with subroutine 293 in FIG. 29(b) for collecting the process image(s), except that the internal loop 2912 pertains to each file descriptor of the process binary in memory. Function 2910 prints the full path of every open file descriptor for the process by recursively following the pointers to each directory entry. In addition to the name and descriptor number it stores their access status (i.e., if they were opened for reading only, writing only, or if they can be both read and written to).

Because command lines are visible in process listings when the process is not hidden, some intruders choose to pass necessary parameters into programs through environment variables. For example, the command line “telnet 10.1.1.10” implies that a connection is being made to the IP address 10.1.1.10. To make things more difficult for an analyst an intruder could export an environment variable with the IP address in it to the program and use only “telnet” on the command line. Therefore, the forensics component also preferably retrieves a copy of the environment from memory as well. An example of a function flow 2914 used to recover this information from memory is shown in FIG. 29(d), and is again similar to that associated with subroutine 293 in FIG. 29(b) for collecting the process image(s), except that a verification 2916 takes place to make sure the environment file can be opened from the proc file system so that an internal loop procedure 2918 can be performed to read a buffer of the binary from memory and write it to the removable media while the environment file still has data in it.

Shared library mappings, mount points, and summary information generally do not provide directly incriminating evidence, but they can be useful in the analysis portion of the behavior of a process or the intentions of an intruder. Flow charts 2920, 2926 & 2930 for collection of these types of process information appear, respectively, as FIGS. 29(e)-(g). As shown in the figures, the functional flow for these items proceed the same as for the file environment above, excepting of course the actual identities of the files retrieved by their respective internal loops 2924, 2928 & 2932.

Another key point of information for a process is the command line used to start the program. Many intruders obfuscate the executables and add “traps” which cause them to operate in a different manor when they are started with incorrect command line options. This is analogous to requiring a special “knock” on a door which tells the person listening if they should answer it or not. Therefore, the forensics component also preferably retrieves an exact copy of the command line used to start the process from memory. This is associated with subroutine 2934 in FIG. 29(h) for collecting the process command lines which loops through the file's entirety at 2936.

Perhaps the most important component of this system is the collection of processes and their corresponding information. Accordingly, with an appreciation of FIGS. 29(a) through 29(h), representative FIG. 29(i) shows an example of what results 267 automatically generated by the forensics component might look like when the process collection routine 229 is implemented. It is again understood that these results can be accessed by clicking on the appropriate link from main page 207 in FIG. 22(b). This table contains: the name of the process, the process ID, a link to both the image from the proc file system and retrieved from memory, a link to the open file descriptors, a link to the environment, shared library mapping information, command line, mount points, and status summary.

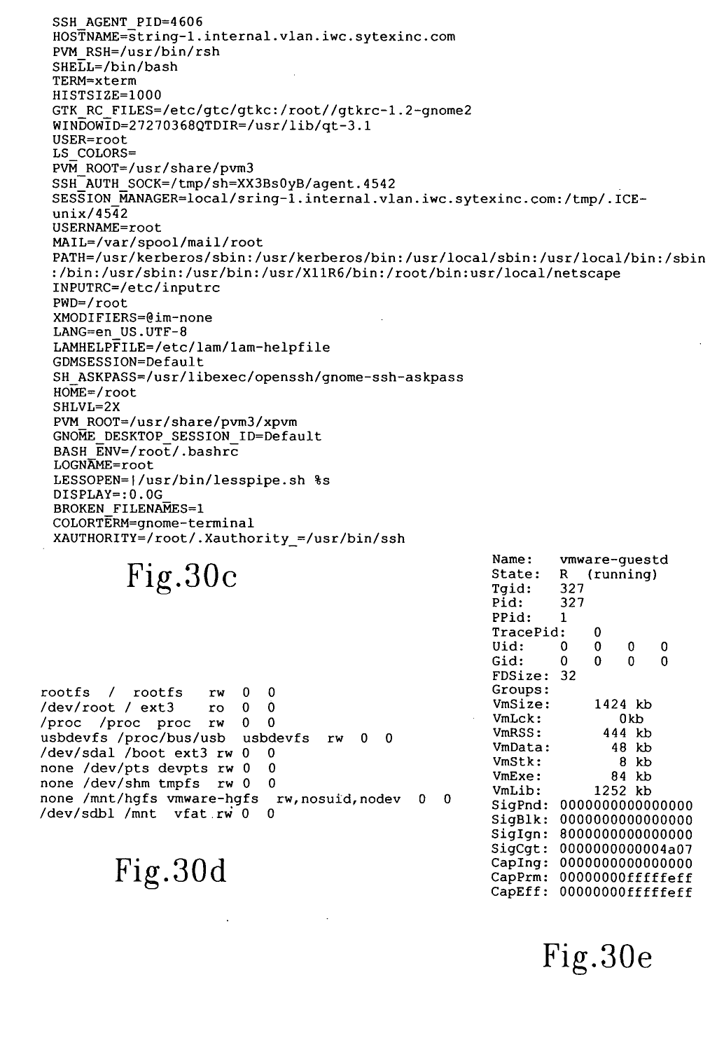

The image links are binary files that can be executed directly from the command line if desired. FIG. 30(a) representatively shows an example of some of the images 269 that could be collected. In most cases both the proc file system image (X.exe) and the memory retrieved image (X.mem_exe) will be identical. However, in instances where the binary is self-decrypting such as PID 603 in FIG. 30(a), the image in memory will be slightly less in size and will not be encrypted like the image from disk. File descriptors give good indications of places to analyze on disk. For instance, the results 271 for PID 582 are shown in FIG. 30(b) This process is syslogd which is responsible for writing to the log files listed above. Similarly, an intruder's program designed to collect passwords and store them on disk will be recovered and listed as well. An example of a recovered environment for sshd is illustrated by the representative listing 273 in FIG. 30(c). A representative example of a recovered mount listing 275 is shown in FIG. 30(d). A representative example of a command line used for VMware is:

/usr/sbin/vmware-guestd

, and a representative example of a recovered status summary 277 is shown in FIG. 30(e).

In order to protect the evidence on the hard drive from being destroyed or corrupted, all evidence is stored on large capacity removable media. The media employed in the proof of concept prototype version is a 256M external USB 2.0 flash drive, but any other device with ample storage capacity can be used. The size of the device directly correlates to the amount of forensics evidence available for collection. For instance, USB hard drives of 1 G or larger in size can also be used to make exact mirror images of all physical memory. However, storage of this data on a USB device can be slow, and other transfer mechanisms such as firewire may be preferred. Regardless of the media type and transfer method, the same methodologies and collection techniques apply.

To prevent contamination of the hard drive it is generally recommended that the external device be mounted, and that the forensics module be stored and executed directly from it. However, in the event that it is desired to have the module itself responsible for mounting the storage device the Linux kernel provides a useful function to create new processes. An example of this is below:

static void mount_removable_media(void) {
call_usermodehelper(“/tmp/mountusb”, NULL, NULL);
}

In this case the forensics kernel module would create a new process and execute a mounting script located in the tmp directory, however it can also be used to compose a legitimate argument structure and call the mount command directly if desired.

At this point 1) all executing processes have been “frozen”, 2) the hard-drive has been forced into a “read-only” mode, and 3) extensive volatile memory evidence has been recovered from the operating system. The next step, referenced at 230 in FIG. 22(a), is to power down the machine and conduct traditional non-volatile hard drive analysis. To ease this process the final function of the module disables all interrupts and directly halts the CPU. This is accomplished with the following two inline assembly functions:

```
static void halt(void) {
    asm(“cli”);
    asm(“hlt”);
}
```

The machine can now be safely powered off and the uncontaminated hard drive can be imaged for additional analysis. Note that the computer must be restarted if process freezing 221 and hard-drive remounting 222 is conducted. The actual detection and collection mechanisms used within this system do not fundamentally require the restarting of the computer. Therefore, this could be used to collect volatile evidence without rebooting if there is no concern for maintaining the integrity of the hard drive.

Even though the forensics collection component has been particularly described in connection with the Linux OS, it will work on other flavors of UNIX, as well as Windows®. In addition, it can be expanded to collect forensics of network information such as connection tables and packet statistics that are stored in memory. As storage devices increase in both size and speed the system can transform itself from targeted collection to general collection with an after-the-fact analytical component. However, the requirement and technique to “freeze” processes and prevent writing to the hard drive will remain the same.

### C. OS Restoration Component

The OS restoration component 16 (FIGS. 2 & 3, above) presents an approach to recovering from operating system exploits without previous base lining or installation of defensive software. This model can be paired with virtually any detection technique, including the exploitation detection component 12 discussed above, to be used as either a reactive or proactive system. The OS restoration component 16 is implemented “after the fact”, meaning that it is used as a remediation technique and not as a preventative measure. The system can be executed when an intrusion is suspected so that the operating system can be returned to a “pre-compromise” or “pre-exploit” state. In such a circumstance, for example, an administrator may sense that something is amiss on the computer system and desire a means of acceptable recovery. Accordingly to the OS restoration component, operating system structures are returned to their original installation values, and intruder processes and files are halted or removed. More particularly, functionalities are provided for the termination of hidden processes, the removal of hidden files, and repair of the kernel from system call table based rootkit attacks. The functionality for computer software routines which implements these capabilities is described below. The ordinarily skilled artisan will recognize that these concepts can also be further expanded, without departing from the inventive teachings contained herein, in order perhaps to build more robust capabilities for recovering from more complex attacks.

Moreover, the artisan will appreciate that, while the description of the restoration component below is one which leverages virtually any detection technique and which is used “after the fact” (i.e., similar to taking an antibiotic drug to fight an infection), it could also be integrated directly into the operating system (i.e., to fight infections automatically like an immune system), or as a combination of both. In the future it can be extended to include an adaptation component. In this case the operating system would be capable of “learning” from the attack, and growing immune if faced with the same or similar situation again. This is analogous to how the body is capable of growing immune to certain diseases following a previous exposure. Ideally the same will be true some day for computer defenses as well.

In addition to being more efficient and practical than traditional reinstallation, the OS restoration component provides a means of automating the entire recovery process. Paired with the exploitation detection and forensics data collection components, operating system compromises can be automatically recovered from “on-the-fly” with little or no administrator intervention. Likewise the healing mechanisms presented here can be expanded to provide an adaptation capability to prevent future attacks.

The self-healing mechanism described here is based on the hybrid anomaly detection technique derived from a set of operating systems premises described above with respect to the exploitation detection component 12. This component similarly uses the successes of immunology to identify fundamental flaws in the behavior of a compromised operating system. Accepting the limitation that this component will not be capable of restoring mortal actions taken or undoing untraceable actions prior to the start of self-healing, it makes its best attempt at recovery from the majority of operating system compromises. Currently it is capable of restoring the system call table, terminating hidden processes, and removing hidden files.

As introduced in FIG. 31, this component too is implemented as a loadable kernel module for Linux 2.4.18. As discussed above, though, the technique can be applied to virtually any operating system because the general methodologies will be similar across different platforms. However, because this component as with the others is implemented at the kernel level, the specific implementation (i.e., coding) will be different. With more particular reference to FIG. 31, OS restoration component 16, preferably incorporates a prototype user interface 312, referred to as “recover” for distinction, which is also a “shell” script programmed in “/bin/sh”. Interface 312 is responsible for starting the associated kernel module (main.c.) 314. Restoration kernel module 314 is loaded, executed and then unloaded and, as with the earlier-described kernel modules, is the primary piece of the OS restoration component 16. It is responsible for recovering the OS from kernel system call table patches, hidden processes, and hidden files. The flow for OS restoration component 16 terminates at 316 once its associated kernel module 314 completes execution.

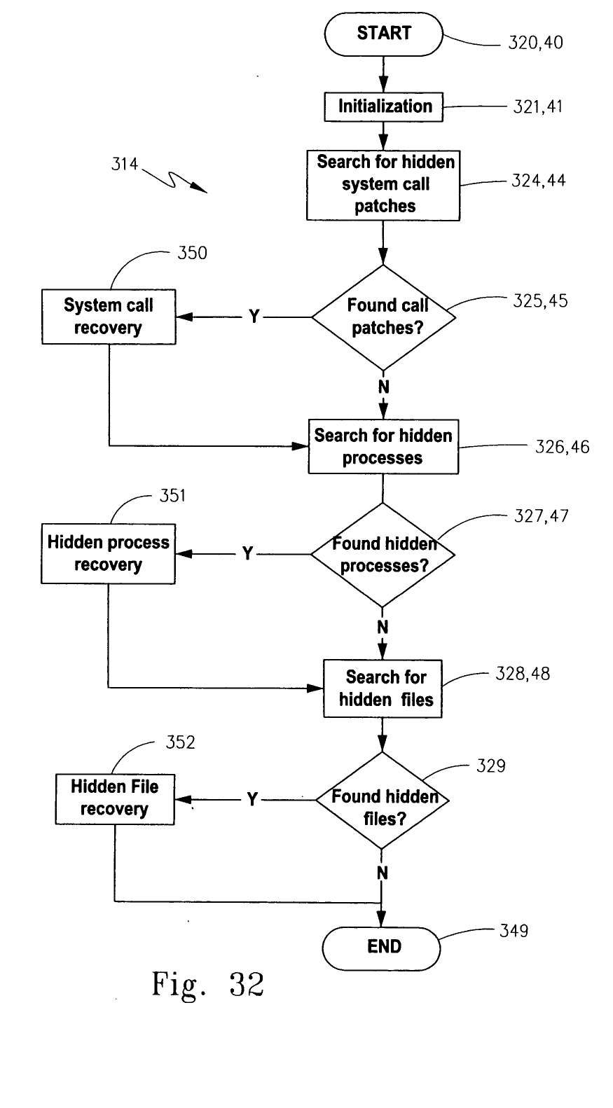

A high-level program flowchart for OS restoration kernel module 314 is shown in FIG. 32. From only a brief perusal of this figure, the reader should readily recognize that various functions incorporated into the restoration kernel module 314 are the same as those discussed above in connection with at least the exploitation detection kernel module 34. Accordingly, a description of these functions need not be repeated for a complete understanding of the OS restoration component of the invention, except perhaps to explain them generally in the context of OS restoration. Thus, the description to follow will, generally speaking, only entail a discussion of those aspects of the OS restoration component which are unique to it.

With this in mind, the program flow for restoration kernel module 314 is very similar to that discussed above in FIG. 4 for exploitation detection kernel module 34. Indeed, once the module begins at 320 and initializes at 321, it proceeds to execute many of the same functions as the exploitation detection kernel module. For sake of clarity and ease of explanation, associated pairs of reference numerals are provided in FIG. 32, and separated by commas, to identify corresponding functions for the restoration and exploitation detection kernel modules which were initially introduced in FIG. 4 above. Since versatility can be provided, as with the forensics component, to either interface the restoration kernel module to the detector's kernel module or allow it to function autonomously, functionality is provide within the component itself to permit this capability. FIG. 4 thus depicts a self-contained restoration component which, as such, replicates many of the functions discussed earlier with reference to the exploitation detection component so that it can function autonomously. As stated above, however, pertinent portions of the restoration component can easily be accessed “on the fly”, via appropriate interface(s), as anomalies are ascertained by the exploit detection component. Accordingly, while there may be a degree of overlap and redundancy between imbedded procedures within the various components, this is provided for completeness in illustrating aspects of the invention, and should not be construed as a limitation on its scope, since it is recognized that the coding of the modules and their associated functions might be dictated by the particular implementation environment.

One notable difference in FIG. 32, however, is that it does not provide a function for searching for hidden modules. In addition, an inquiry is provided at 329 in FIG. 32 to ascertain if any hidden files were found in response to the hidden files search at 328. This was not provided in the exploitation detection's kernel module since it incorporated a subsequent Perl script for the purpose of generating results based on a user space/kernel space file comparison. Also, rather than generating output results as occurred with the exploitation detection's kernel module, restoration kernel module 314 provides for various recovery algorithms 350-352, each based on results from a respective search 324, 326 and 328. Indeed, only these recovery routines 350-351 need be described in order to have a complete understanding of restoration kernel module 314.

FIG. 33, thus, represents a flow chart for computer software implementing the system call table recovery algorithm 350 shown of FIG. 32. In operation, a pointer is made to the start of the kernel symbols. From this point each symbol is compared to see if it matches to the name of the system call in question. If it matches, the address of the function within the system call table is replaced with the address of the corresponding symbol. As more particularly shown in FIG. 33, initialization takes place at 330 when the algorithm is called to prepare the necessary data structures and pointers into the kernel symbol table. As an input it receives the name of the function within the system call table that has been modified. A loop is initiated at 332 through all names within the kernel symbol table. If the encountered name in the symbol table matches at 334 to the name of the patched system call table function, then the address of the symbol is patched over the modified address of the system call table at 336. Otherwise, once the loop has finished analyzing all names within the kernel symbol table, it ends at 338 and the algorithm returns at 339.

The strength of the system call table recovery function is its ability to heal the kernel from malicious software. Intruders generally “patch” over lookup addresses within the system call table to redirect legitimate applications to use their tainted software. This system repairs the system call table by replacing addresses that are determined to be malicious by the detection module. Although addresses for the system calls are not exported globally for general usage, they can be determined by searching through the kallsyms structure within kernel memory. The malicious addresses within the system call table can then be replaced with the legitimate addresses as described in FIG. 33.

Once a process has been identified as hidden by an external detection component, such as exploitation detection component 12, it is available for termination by restoration component 16. The component can be configured to automatically terminate all hidden processes (i.e., no human intervention), automatically terminate only processes that match a particular criteria (i.e., a process that appears to be socket related or a process that appears to be a network traffic sniffer), or query the user to interactively terminate selected processes. The current embodiment depicted in FIG. 34 serves to terminates all processes that are hidden from the user. It operates by removing pointers to the memory management structure, file descriptor structure, file system structure, and sending a “hang up” signal to the process. This will force the process to immediately halt and cease functioning cleanly. The memory management structure (p->mm) is also set to NULL which will for the process to terminate as a coredump if the attacker has implemented signal handling internally to ignore external signals.

Reference is particularly made to FIG. 34. Upon initializing at 340, this function 351 receives the ID of a process that is hidden and therefore should be terminated. Again, appropriate data structures and pointers to memory for this process are prepared. At 342, the write lock for the task structure which references this process is acquired so that it can be modified. At 344 pointers are removed for the memory management, the file descriptors, the file system; and, the process task is assigned the “death signal”. This series of events effectively terminates the process and prevents it from further execution. The write lock for the process which has been terminated is then released, and algorithm 351 returns at 348.

Finally, the hidden file removal algorithm 352 is shown in FIG. 35. This is another area of healing for a compromised system, and accomplishes removal of files that are otherwise invisible to administrators. It should be noted that this function is based on the open-source “removal” functionality within the Linux operating system. There is essentially only one way to remove the file from the kernel, as outline by FIG. 35. At 352 the function initially receives, from the file system, the name of the file that should be removed. It starts by filling the nameidata structure with information via the space path_init( ) kernel function. At 354, traversal is made down all of the full path elements until the directory is reached which houses the file to be terminated. Once at the correct level, the kernel function lookup_hash( ) is called at 356 to obtain the pointer to the directory entry of the file. The kernel function vfs_unlink( ) is then called at 358 to remove the directory entry (i.e. the file) from the file system. Thereafter, function 352 completes and returns at 359.

In its current implementation, when the user executes this OS restoration component 16, the user is initially asked if hidden file removal is desired. If the user selects “NO” and only wishes to recover the system call table the file becomes “unhidden” by the mere fact that the intruders kernel rootkit is no longer operating. While the component is currently only configured to remove a single file marked as “hidden” by the rootkit, it could easily be expanded to interactively query the user for each file, or even make copies of the files into a “quarantined” location prior to removing them from the system.

The functions described are capable of recovering or “disinfecting” against most popular kernel rootkits. Enhancements, however, could be made to expand the recovery capability to heal from more sophisticated “non-public” kernel attacks that do not operate by patching the system call table. One possible approach for doing this is to expand the kernel healing to implement a call graph table trace of all possible malicious patch points. For instance, the address of the system call will be determined through the approach demonstrated above. The function pointed to by the address will then be inspected to identify all assembly “CALL” or “JUMP” instructions. The address of each call will be recursively followed for their list of “CALL” or “JUMP” instructions. Eventually an exhaustive graph of all possible calls will be generated for each system call address. This graph can be inspected for addresses that fall outside the trusted kernel memory range, and their subsequent calling function can be repaired. Implementing this graphing capability should provide a mechanism to recover from all kernel modifications. It should be noted, however, that the success of this capability will be determined by the ability to determine replacement or recovery addresses for the modified functions.

Another type of enhancement could be the automated recovery of user space applications such as 1) trojaned programs and 2) vulnerable services. Healing from user space modifications is a simple process that merely requires replacing the infected application with a pristine version. However, this requires a database of pristine applications available for automated download and installation. As intruders are becoming more sophisticated and transitioning attacks from user space to kernel rootkits this may be less of a requirement.

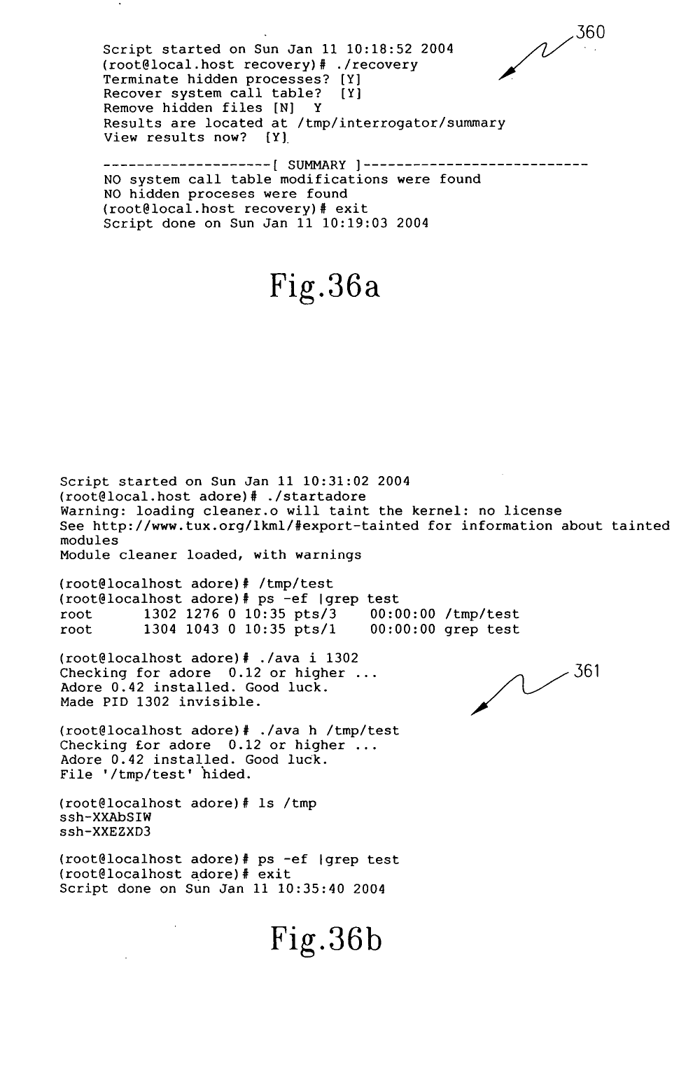

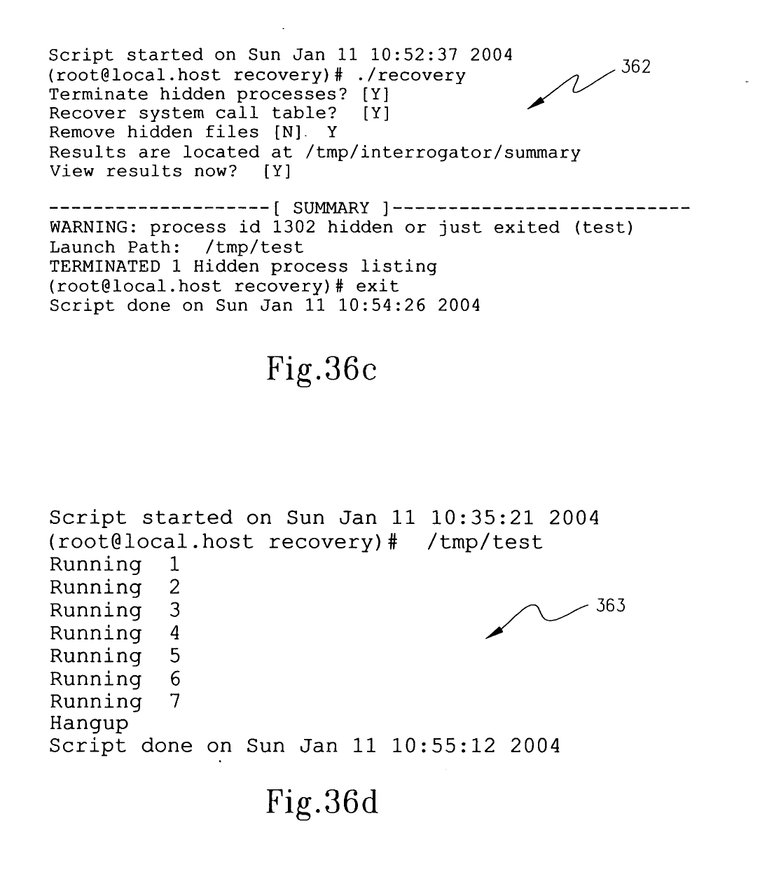

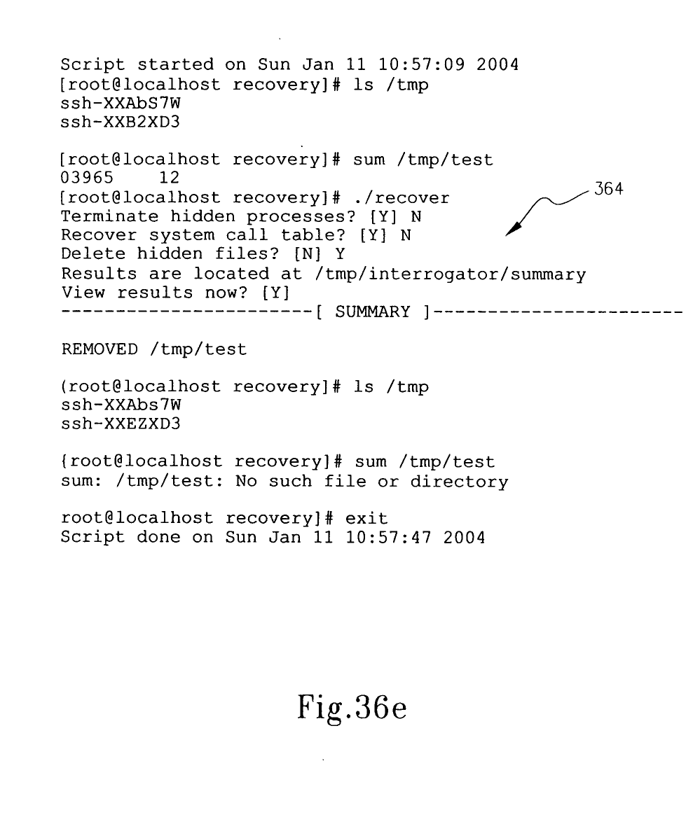

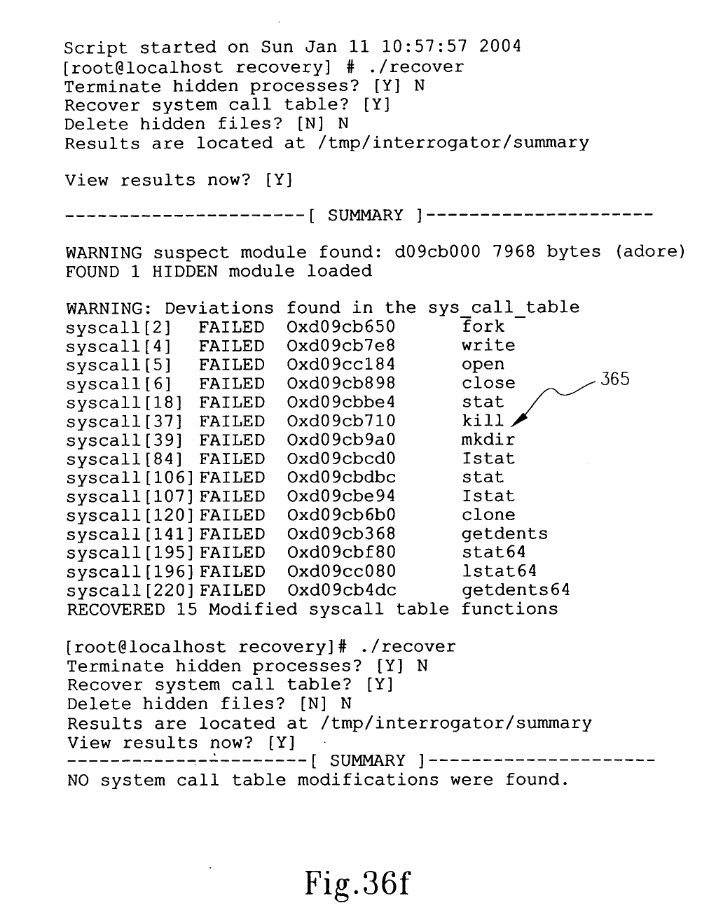

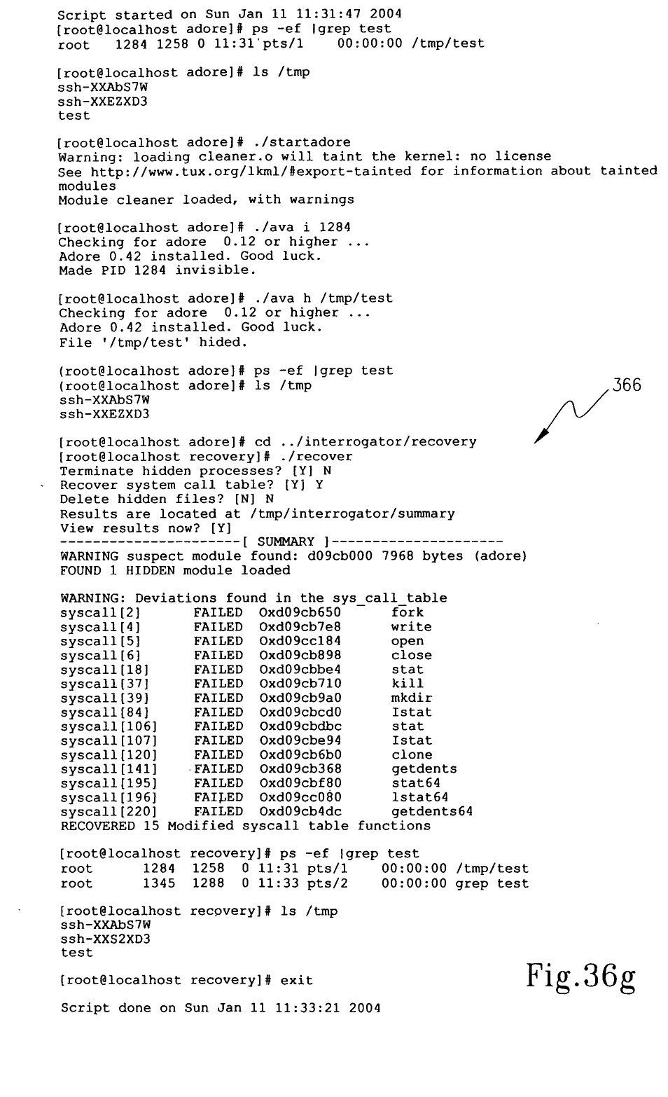

Having described in sufficient detail the OS restoration component 16, reference is now made to FIGS. 36(a)-36(g) to illustrate representative results obtained when the component was tested against the Adore v.0.42 kernel rootkit. The system was first run against a clean installation of Linux 2.4.18 to generate a first results listing 360 shown in FIG. 36(a). Following a clean system test, the kernel rootkit Adore was installed, as illustrated by the listing 361 in FIG. 36(b). At this point it may be seen that the system call table has been modified, the process ID “1302” is hidden, and the file “/tmp/test” has been hidden.

The OS restoration component may first be used to terminate the process hidden by the rootkit. FIG. 36(c) shows the output 362 of running the program after the rootkit has been installed, and FIG. 36(d) shows the output 363 of the process as it was terminated. Next the OS restoration component was used to remove the file hidden by the rootkit. See output listing 364 of FIG. 36(e). Adore has the weakness that individual files can be listed if their name is known. Therefore, a checksum is run against the file before and after to prove that it was successfully deleted while hidden. Next, the recovery system was used to recover the system call table, as illustrated by results listing 365 in FIG. 36(f).

Finally, FIG. 36(g) illustrates output results 366 for a second recovery run against the system call table to demonstrate that it was repaired successfully and that the module Adore is no longer installed. This can also be demonstrated by recovering the system call table without terminating the hidden process or removing the hidden file. In this example the process ID “1284” and the file “/tmp/test” are both visible initially. The rootkit is then installed and both immediately become hidden from standard inspection methods. Following execution of the OS restoration component, both the process and the file become visible again. This is because the kernel has become “disinfected” from the kernel rootkit. The module is still located in memory, but all function calls to it have been disabled. In the future this system can be expanded to physically remove the function from memory as well.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A computer security system, comprising:
(a) a non-volatile memory;
(b) a volatile memory; and
(c) a processor programmed to:
(1) detect exploitation of a computer operating system which is of a type that renders the computer insecure; and
(2) initiate a response to detection of said exploitation, which response entails at least one of:
(i) collecting forensics data characteristic of the exploitation; and
(ii) restoring the operating system to a pre-exploitation condition.

2. A computer security system according to claim 1 including a storage device.

3. A computer security system according to claim 2 wherein said storage device is removable.

4. A computer security system according to claim 1 wherein said response entails collecting forensics data characteristic of the exploitation, with the forensics data being transferred for storage onto a storage device.

5. A computer security system according to claim 4 wherein collection of said forensics data preliminarily includes halting all unnecessary processes on the computer and remounting all drives associated with said non-volatile memory.

6. A computer security system according to claim 1 wherein said forensics data is collected without utilizing resources of said non-volatile memory.

7. A computer security system according to claim 1 wherein said forensics data is collected in a manner which preserves integrity of non-volatile memory data.

8. A computer security system according to claim 1 whereby said forensics data is collected in a manner which preserves integrity of both volatile memory data and non-volatile memory data.

9. A computer security system according to claim 1 wherein said exploitation is selected from a group of comprises consisting of hidden kernel modules, hidden system call patches, hidden processes, and hidden files.

10. A computer security system according to claim 10 wherein said response entails restoring said operating system to a pre-exploitation condition by removing any hidden kernel modules, removing any hidden system call patches, terminating any hidden processes, and removing any hidden files which have been detected.

11. A computer security system, comprising:
(a) removable storage means;
(b) non-volatile memory;
(c) volatile memory; and
(d) processing means programmed for:
(1) detecting exploitation of a computer operating system which is of a type that renders the computer insecure; and
(2) initiating a response to detection of said exploitation, which response entails at least one of:
(i) collecting forensics data characteristic of the exploitation whereby it is stored on the removable media means; and
(ii) restoring the operating system to a pre-exploitation condition.

12. A computer security system according to claim 11 wherein collection of said forensics data preliminarily includes halting all unnecessary processes on the computer and remounting all drives associated with said non-volatile memory means.

13. A computer security system according to claim 11 wherein said forensics data is collected in a manner which preserves integrity of non-volatile memory data.

14. A computer security system according to any of claims 11 and 13 wherein said forensics data is collected in a manner which preserves integrity of volatile memory data.

15. A computer security system according to claim 11 wherein said exploitation is selected from a group of comprises consisting of hidden kernel modules, hidden system call patches, hidden processes, and hidden files, and wherein said response entails restoring said operating system to a pre-exploitation condition by removing any hidden kernel modules, removing an system call patches, terminating any hidden processes, and removing any hidden files which have been detected.

16. A computer-readable medium for use with a computer and having executable instructions for performing a method comprising:
(a) detecting exploitation of an operating system which renders a computer insecure; and
(b) initiating a response to detection of said exploitation, said response entailing at least one of:
(1) enabling transfer of data characteristic of the exploitation onto a removable storage device; and
(2) restoring the operating system to a pre-exploitation condition.

17. A computer-readable medium according to claim 16 wherein said removable storage device is an external flash drive.

18. A computer-readable medium according to claim 16 wherein the executable instructions accomplish halting of all unnecessary processes and remounting of all drives associated prior to data transfer.

19. A computer-readable medium according to claim 16 wherein the executable instructions enable data transfer in a manner which preserves integrity of non-volatile memory data on the computer.

20. A computer-readable medium according to claim 16 wherein the executable instructions enable data transfer in a manner which preserves integrity of volatile memory data on the computer.

21. A computer-readable medium according to claim 16 wherein the executable instructions enable data transfer in a manner which preserves integrity of both volatile memory data and non-volatile memory data on the computer.

22. A computer-readable medium according to claim 16 wherein said exploitation is selected from a group of comprises consisting of hidden kernel modules, hidden system call patches, hidden processes, and hidden files.

23. A computer-readable medium according to claim 16 wherein the executable instructions enable restoration of said operating system to a pre-exploitation condition by removing any hidden kernel modules, removing any system call patches, terminating any hidden processes, and removing any hidden files which have been detected.

24. A computer-readable medium for use with a host computer that includes an associated operating system, non-volatile memory, and volatile memory, said computer-readable medium having executable instructions for performing a method comprising:
detecting an occurrence of exploitation to the operating system which renders the host computer insecure;
collecting, from said volatile memory, forensics data that is characteristic of the exploitation;
transferring said forensics data onto a removable storage device in a manner which preserves integrity of other data residing in said non-volatile memory; and
restoring the operating system to a pre-exploit condition.

25. A computer-readable medium according to claim 24 wherein said removable storage device is an external USB flash drive.

26. A computer-readable medium according to claim 24 wherein collection of said forensics data preliminarily includes halting all unnecessary processes on the computer and remounting all drives associated with said non-volatile memory.

27. A computer-readable medium according to claim 24 wherein the executable instructions enable collection of said forensics data in a manner which preserves integrity of volatile memory data.

28. A computer-readable medium according to claim 24 wherein the executable instructions enable collection of said forensics data in a manner which preserves integrity of both volatile memory data and non-volatile memory data.

29. A computer-readable medium according to claim 24 wherein said exploitation is selected from a group of comprises consisting of hidden kernel modules, hidden system call patches, hidden processes, and hidden files and wherein the executable instructions enable restoration of the operating system to a pre-exploitation condition by removing any hidden kernel modules, removing an system call patches, terminating any hidden processes, removing any hidden files which have been detected.

30. A computer-readable medium according to claim 24 wherein said method is accomplished by a plurality of interfaced, loadable kernel modules which, collectively, contain the executable instructions.

31. A security software product for use on a host computer to monitor for, and respond to, activity corresponding to a rootkit exploitation which renders the host computer's operating system (OS) insecure, said security software product comprising:
(a) computer readable media having a suite of integrated software components adapted to interface with one another, said software components including:
(1) an exploitation detection component having executable instructions for detecting the activity corresponding to said rootkit exploitation;
(2) a forensics data collection component interfaced with said exploitation detection component for collecting forensics data characteristic of said rootkit exploitation so that said forensics data may be transferred to a removable storage device; and
(3) a OS restoration component interfaced with said exploitation detection component for restoring said operating system to a secure condition in response to detection of said activity.

32. A security software product according to claim 31 wherein said exploitation detection component is capable of detecting signature-based on non-signature-based activity corresponding to a rootkit exploitation.

33. A security software product according to claim 31 wherein said activity is selected from a group of compromises consisting of hidden kernel modules, hidden system call patches, hidden processes, and hidden files, and hidden ports.

34. A security software product according to claim 31 system wherein said forensics data collection component is operative to preliminarily halt unnecessary processes on the computer and remount all drives associated with the computer's non-volatile memory.

35. A security software product according to claim 31 wherein said forensics data collection component is operative to collect forensics data without using non-volatile memory resources, while preserving integrity of volatile memory data.

36. A security software product according to claim 31 wherein said OS restoration component is operative to remove any hidden kernel modules, remove any system call patches, remove any hidden files, and to terminate any hidden processes detected by said exploitation detection component.

37. A security software product for use on a host computer running a Linux operating system to monitor for, and respond to, activity corresponding to a rootkit exploitation which renders the host computer insecure, said security software product comprising:
(a) a computer readable medium having a plurality of integrated software components adapted to interface with one another, said software components including:
(1) a first loadable kernel module having associated first executable instructions for detecting an occurrence of said rootkit exploitation;
(2) a second loadable kernel module interfaced with said first kernel module, and having associated second executable instructions for collecting forensics data characteristic of said rootkit exploitation and for enabling said forensics data to be transferred for storage onto a removable storage device; and
(3) a third loadable kernel module interfaced with said first kernel module, and having associated third executable instructions for restoring said operating system to a secure condition in response to detection of said rootkit exploitation by said first kernel module.

38. A security software product according to claim 37 system wherein said second loadable kernel module is operative to preliminarily halt unnecessary processes on the computer and remount all drives associated with the computer's non-volatile memory.

39. A security software product according to claim 31 wherein said forensics data collection component is operative to collect forensics data without using non-volatile memory resources, while preserving integrity of volatile memory data, and wherein said OS restoration component is operative to remove any hidden kernel modules, remove any system call patches, remove any hidden files, and to terminate any hidden processes detected by said exploitation detection component.

40. A computerized method, comprising:
(a) monitoring activity within a computer operating system in order to detect occurrence of an exploitation which renders the computer insecure, and thereafter performing at least one of:
(1) collecting forensics data characteristic of the exploitation in a manner which preserves integrity of characteristic information stored in both non-volatile and volatile memory resources of the computer; and
(2) restoring the operating system to a pre-exploitation condition.

41. A computerized method according to claim 40 comprising transferring said forensics data located in volatile memory resources on the computer onto a removable storage device.

42. A computerized method according to claim 40 whereby forensics data located with said volatile memory resources is collected prior to powering down the computer.

43. A computerized method according to claim 40 comprising preliminarily halting all processes on the computer and remounting all drives associated with said non-volatile memory.

44. A computerized method according to claim 40 comprising monitoring activity relating attempts to hide kernel modules, system call patches, processes, and files.

45. A computer security system according to claim 40 whereby restoration of the operating system is accomplished removing any hidden kernel modules, removing an system call patches, terminating any hidden processes, and removing any hidden files.
